(19) United States
(12) Patent Application Publication
(10) Pub. No.: US 2026/0291596 A1
(43) Pub. Date: Sep. 24, 2026

(54) PRIORITIZED TRANSMISSION CONFIGURATION INDICATOR (TCI) STATE IN UNIFIED TCI OR SINGLE-FREQUENCY NETWORK OPERATION

(71) Applicant: QUALCOMM Incorporated, San Diego, CA (US)

(72) Inventors: Fang YUAN, Beijing (CN); Yan ZHOU, San Diego, CA (US); Tao LUO, San Diego, CA (US)

(21) Appl. No.: 18/874,289

(22) PCT Filed: Aug. 26, 2022
(86) PCT No.: PCT/CN2022/115006

§ 371 Date: Dec. 12, 2024

(51) Int. Cl. H04B 7/06; H04L 5/00; H04W 72/231; H04W 72/566

(52) U.S. Cl. CPC H04B 7/06968; H04L 5/001; H04L 5/0044; H04W 72/231; H04W 72/566

(57) ABSTRACT

Various aspects of the present disclosure generally relate to wireless communication. In some aspects, a mobile station may receive a unified transmission configuration indicator (TCI) indication indicating a first TCI state associated with a physical downlink shared channel (PDSCH) communication, wherein time resources associated with the PDSCH communication at least partially overlap with time resources associated with a control resource set (CORESET) associated with a second TCI state different from the first TCI state. The mobile station may prioritize reception of a physical downlink control channel (PDCCH) communication associated with the CORESET based at least in part on the second TCI state being different from the first TCI state. Numerous other aspects are described.

### FIELD OF THE DISCLOSURE

Aspects of the present disclosure generally relate to wireless communication and to techniques and apparatuses for a prioritized transmission configuration indicator (TCI) state in unified TCI or single-frequency network operation.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a mobile station. The method may include receiving, by the mobile station, a unified transmission configuration indicator (TCI) indication indicating a first TCI state associated with a physical downlink shared channel (PDSCH) communication, wherein time resources associated with the PDSCH communication at least partially overlap with time resources associated with a control resource set (CORESET) associated with a second TCI state different from the first TCI state. The method may include prioritizing, by the mobile station, reception of a physical downlink control channel (PDCCH) communication associated with the CORESET based at least in part on the second TCI state being different from the first TCI state.

Some aspects described herein relate to a method of wireless communication performed by a mobile station. The method may include receiving, by the mobile station, a scheduling downlink control information (DCI) communication associated with a single-frequency network (SFN) PDSCH communication, wherein the scheduling DCI communication indicates a first TCI state associated with the SFN PDSCH communication, and wherein time resources associated with the SFN PDSCH communication at least partially overlap with time resources associated with a CORESET associated with a second TCI state different from the first TCI state. The method may include prioritizing, by the mobile station, reception of a PDCCH communication associated with the CORESET based at least in part on the second TCI state being different from the first TCI state.

Some aspects described herein relate to a mobile station for wireless communication. The mobile station may include a memory and one or more processors coupled to the memory. The one or more processors may be configured to receive a unified TCI indication indicating a first TCI state associated with a PDSCH communication, wherein time resources associated with the PDSCH communication at least partially overlap with time resources associated with a CORESET associated with a second TCI state different from the first TCI state. The one or more processors may be configured to prioritize reception of a PDCCH communication associated with the CORESET based at least in part on the second TCI state being different from the first TCI state.

Some aspects described herein relate to a mobile station for wireless communication. The mobile station may include a memory and one or more processors coupled to the memory. The one or more processors may be configured to receive a scheduling DCI communication associated with an SFN PDSCH communication, wherein the scheduling DCI communication indicates a first TCI state associated with the SFN PDSCH communication, and wherein time resources associated with the SFN PDSCH communication at least partially overlap with time resources associated with a CORESET associated with a second TCI state different from the first TCI state. The one or more processors may be configured to prioritize reception of a PDCCH communication associated with the CORESET based at least in part on the second TCI state being different from the first TCI state.

Some aspects described herein relate to a non-transitory computer-readable medium that stores a set of instructions for wireless communication by a mobile station. The set of instructions, when executed by one or more processors of the mobile station, may cause the mobile station to receive a unified TCI indication indicating a first TCI state associated with a PDSCH communication, wherein time resources associated with the PDSCH communication at least partially overlap with time resources associated with a CORESET associated with a second TCI state different from the first TCI state. The set of instructions, when executed by one or more processors of the mobile station, may cause the mobile station to prioritize reception of a PDCCH communication associated with the CORESET based at least in part on the second TCI state being different from the first TCI state.

Some aspects described herein relate to a non-transitory computer-readable medium that stores a set of instructions for wireless communication by a mobile station. The set of instructions, when executed by one or more processors of the mobile station, may cause the mobile station to receive a scheduling DCI communication associated with an SFN PDSCH communication, wherein the scheduling DCI communication indicates a first TCI state associated with the SFN PDSCH communication, and wherein time resources associated with the SFN PDSCH communication at least partially overlap with time resources associated with a CORESET associated with a second TCI state different from the first TCI state. The set of instructions, when executed by one or more processors of the mobile station, may cause the mobile station to prioritize reception of a PDCCH communication associated with the CORESET based at least in part on the second TCI state being different from the first TCI state.

Some aspects described herein relate to an apparatus for wireless communication. The apparatus may include means for receiving a unified TCI indication indicating a first TCI state associated with a PDSCH communication, wherein time resources associated with the PDSCH communication at least partially overlap with time resources associated with a CORESET associated with a second TCI state different from the first TCI state. The apparatus may include means for prioritizing reception of a PDCCH communication associated with the CORESET based at least in part on the second TCI state being different from the first TCI state.

Some aspects described herein relate to an apparatus for wireless communication. The apparatus may include means for receiving a scheduling DCI communication associated with an SFN PDSCH communication, wherein the scheduling DCI communication indicates a first TCI state associated with the SFN PDSCH communication, and wherein time resources associated with the SFN PDSCH communication at least partially overlap with time resources associated with a CORESET associated with a second TCI state different from the first TCI state. The apparatus may include means for prioritizing reception of a PDCCH communication associated with the CORESET based at least in part on the second TCI state being different from the first TCI state.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with user equipment (UE) in a wireless network, in accordance with the present disclosure.

FIG. 3 is a diagram illustrating an example disaggregated base station architecture, in accordance with the present disclosure.

FIG. 4 is a diagram illustrating an example resource structure for wireless communication, in accordance with the present disclosure.

FIG. 5 is a diagram illustrating an example of transmission reception point differentiation at a UE based at least in part on a control resource set pool index, in accordance with the present disclosure.

FIG. 6 is a diagram illustrating an example of using beams for access link communications between a network node and a UE, in accordance with the present disclosure.

FIG. 7 is a diagram illustrating an example associated with a prioritized transmission configuration indication (TCI) state in a unified TCI operation, in accordance with the present disclosure.

FIGS. 8A-8B are diagrams illustrating another example associated with a prioritized TCI state in a unified TCI operation, in accordance with the present disclosure.

FIG. 9 is a diagram illustrating an example associated with a prioritized TCI state in a single-frequency network operation, in accordance with the present disclosure.

FIG. 10 is a diagram of an example associated with a prioritized TCI state in a unified TCI or a single-frequency network operation, in accordance with the present disclosure.

FIG. 11 is a diagram illustrating an example process performed, for example, by a mobile station, in accordance with the present disclosure.

FIG. 12 is a diagram illustrating an example process performed, for example, by a mobile station, in accordance with the present disclosure.

FIG. 13 is a diagram of an example apparatus for wireless communication, in accordance with the present disclosure.

FIG. 14 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

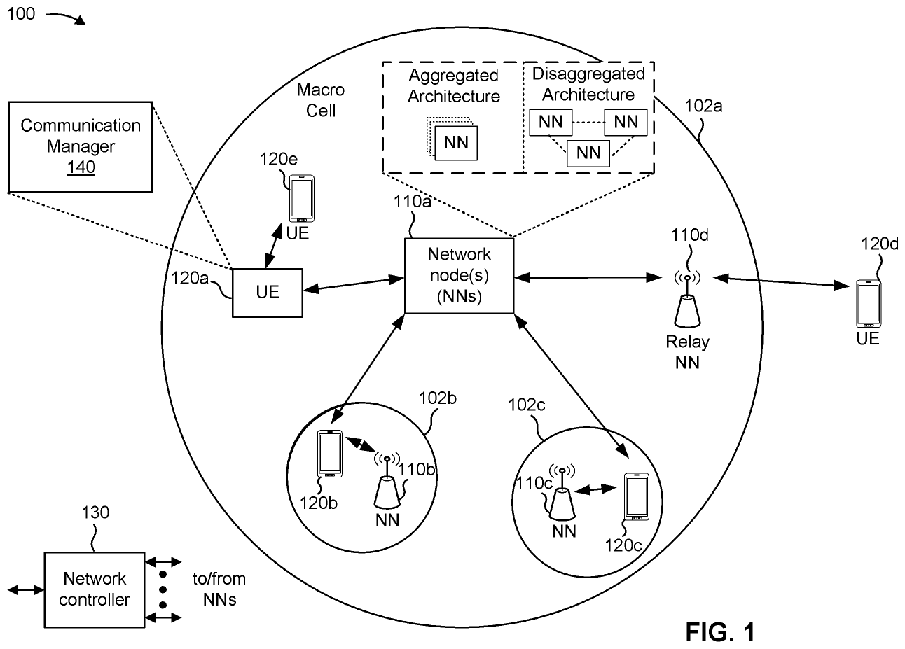

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes (NNs) 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the term “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the term “base station” or “network node” may refer to one device configured to perform one or more functions, such as those described herein in connection with the network node 110. In some aspects, the term “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the term “base station” or “network node” may refer to any one or more of those different devices. In some aspects, the term “base station” or “network node” may refer to one or more virtual base stations or one or more virtual base station functions. For example, in some aspects, two or more base station functions may be instantiated on a single device. In some aspects, the term “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHZ) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may correspond to a mobile station described elsewhere herein. Moreover, in some aspects, the UE 120 may include a communication manager 140. As described in more detail elsewhere herein, the communication manager 140 may receive a unified transmission configuration indicator (TCI) indication indicating a first TCI state associated with a physical downlink shared channel (PDSCH) communication, wherein time resources associated with the PDSCH communication at least partially overlap with time resources associated with a control resource set (CORESET) associated with a second TCI state different from the first TCI state; and prioritize reception of a physical downlink control channel (PDCCH) communication associated with the CORESET based at least in part on the second TCI state being different from the first TCI state. Additionally, or alternatively, the communication manager 140 may receive a scheduling downlink control information (DCI) communication associated with a single-frequency network (SFN) PDSCH communication, wherein the scheduling DCI communication indicates a first TCI state associated with the SFN PDSCH communication, and wherein time resources associated with the SFN PDSCH communication at least partially overlap with time resources associated with a CORESET associated with a second TCI state different from the first TCI state; and prioritize reception of a PDCCH communication associated with the CORESET based at least in part on the second TCI state being different from the first TCI state. Additionally, or alternatively, the communication manager 140 may perform one or more other operations described herein.

As indicated above, FIG. 1 is provided as an example. Other examples may differ from what is described with regard to FIG. 1.

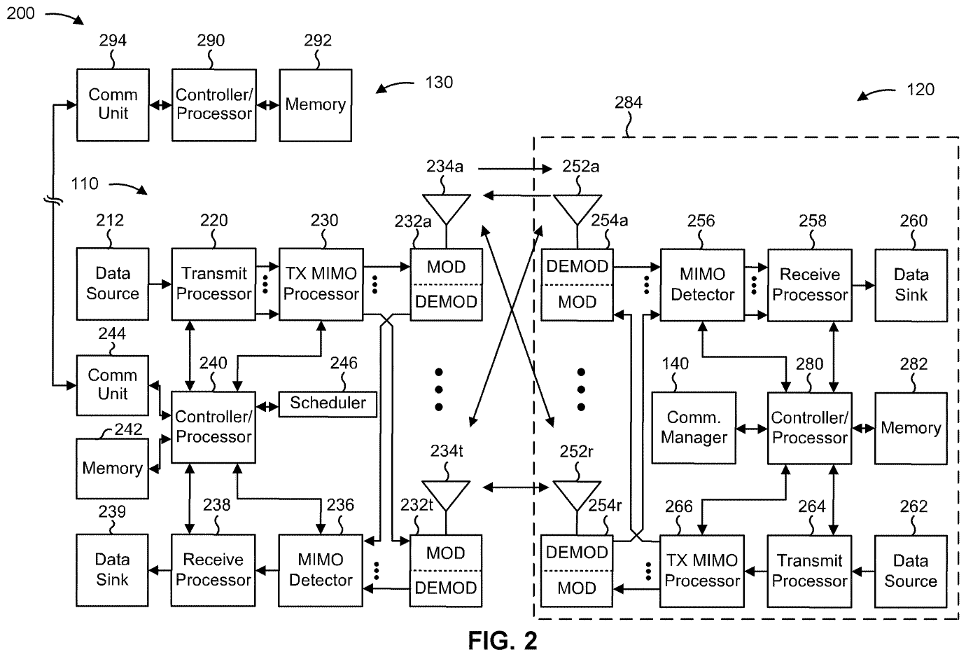

FIG. 2 is a diagram illustrating an example 200 of a network node 110 in communication with UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., Toutput symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

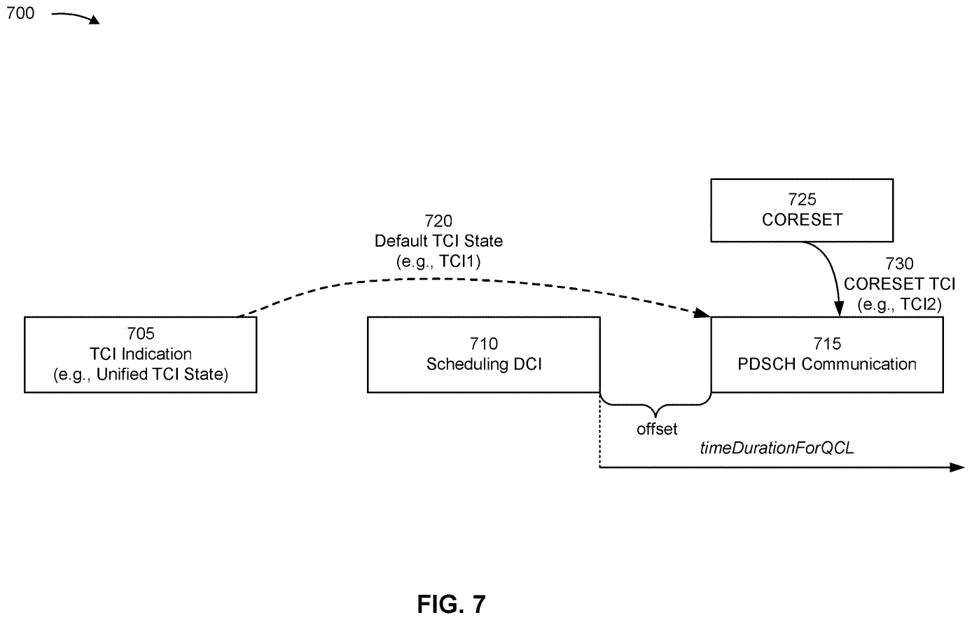

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 7-14).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 7-14).

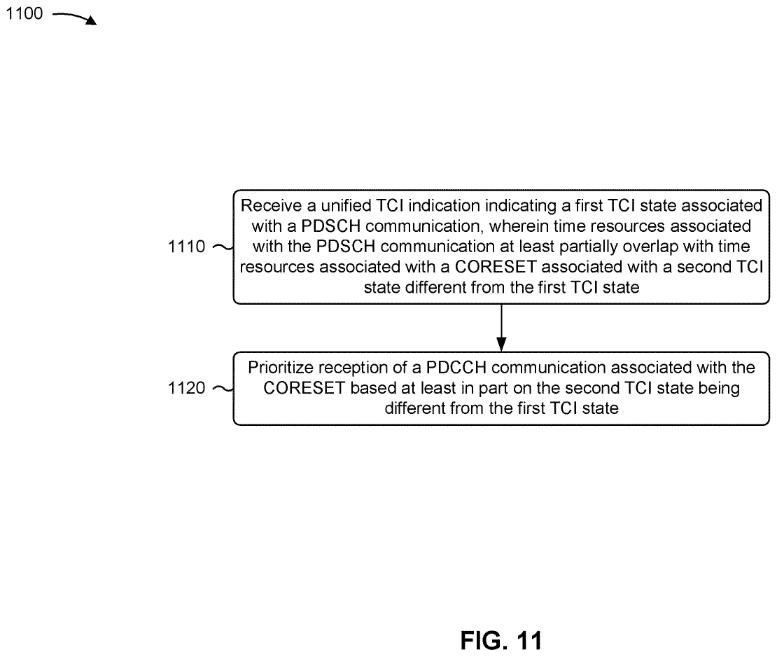

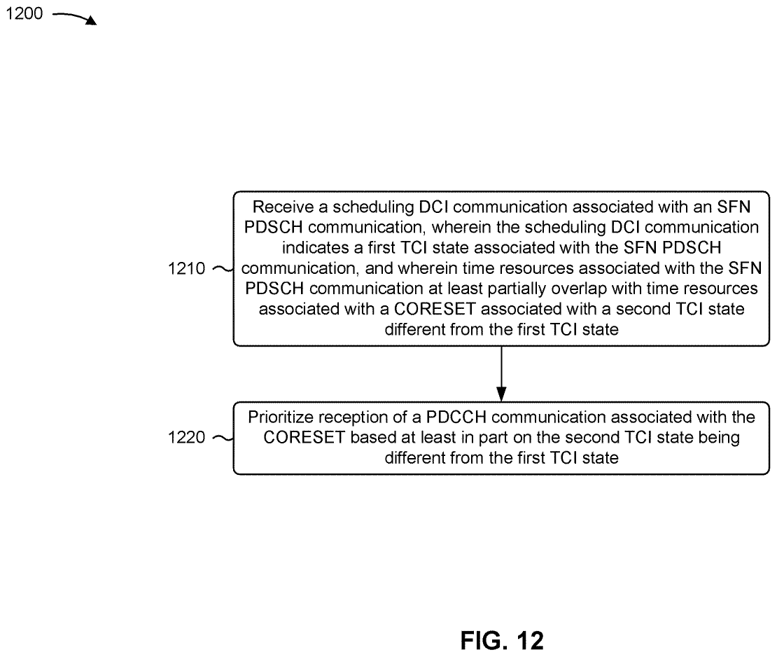

The controller/processor 240 of the network node 110, the controller/processor 280 of the UE 120, and/or any other component(s) of FIG. 2 may perform one or more techniques associated with a prioritized TCI state in unified TCI or single-frequency network operation, as described in more detail elsewhere herein. In some aspects, the mobile station described herein is the UE 120, is included in the UE 120, or includes one or more components of the UE 120 shown in FIG. 2. The controller/processor 240 of the network node 110, the controller/processor 280 of the UE 120, and/or any other component(s) of FIG. 2 may perform or direct operations of, for example, process 1100 of FIG. 11, process 1200 of FIG. 12, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 1100 of FIG. 11, process 1200 of FIG. 12, and/or other processes as described herein. In some examples, executing instructions may include running the instructions, converting the instructions, compiling the instructions, and/or interpreting the instructions, among other examples.

In some aspects, the mobile station includes means for receiving a unified TCI indication indicating a first TCI state associated with a PDSCH communication, wherein time resources associated with the PDSCH communication at least partially overlap with time resources associated with a CORESET associated with a second TCI state different from the first TCI state; and/or means for prioritizing reception of a PDCCH communication associated with the CORESET based at least in part on the second TCI state being different from the first TCI state. In some aspects, the means for the mobile station to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the mobile station includes means for receiving a scheduling DCI communication associated with an SFN PDSCH communication, wherein the scheduling DCI communication indicates a first TCI state associated with the SFN PDSCH communication, and wherein time resources associated with the SFN PDSCH communication at least partially overlap with time resources associated with a CORESET associated with a second TCI state different from the first TCI state; and/or means for prioritizing reception of a PDCCH communication associated with the CORESET based at least in part on the second TCI state being different from the first TCI state. In some aspects, the means for the mobile station to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

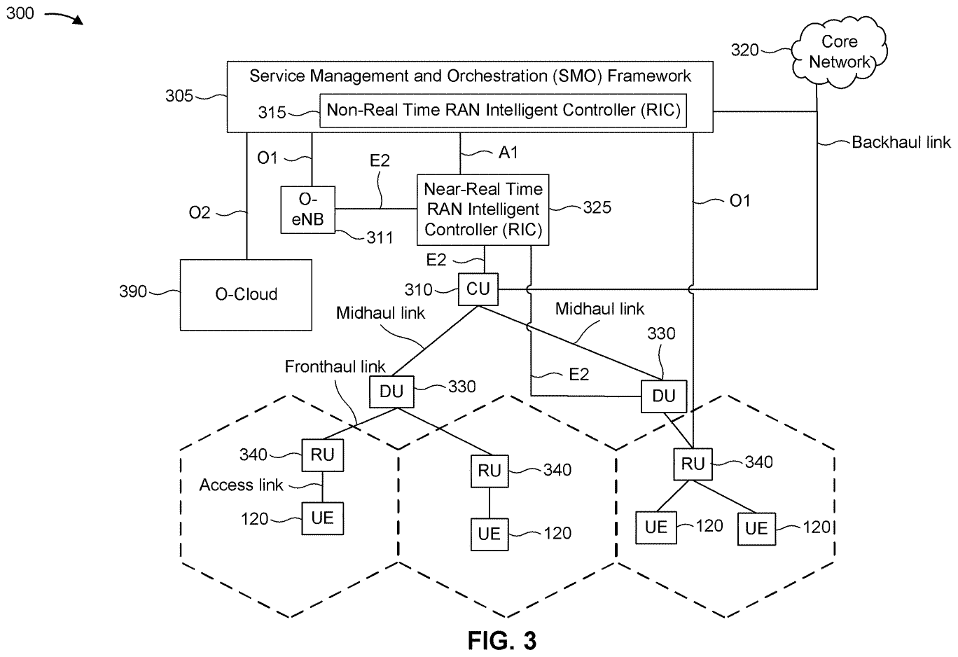

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an Ol interface) or via creation of RAN management policies (such as Al interface policies).

As indicated above, FIG. 3 is provided as an example. Other examples may differ from what is described with regard to FIG. 3.

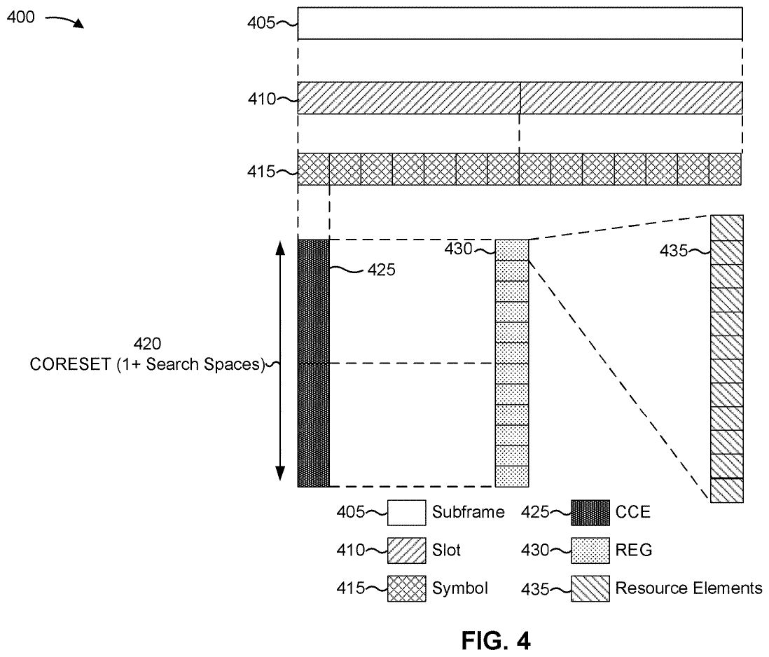

FIG. 4 is a diagram illustrating an example resource structure 400 for wireless communication, in accordance with the present disclosure. Resource structure 400 shows an example of various groups of resources described herein. As shown, resource structure 400 may include a subframe 405. Subframe 405 may include multiple slots 410. While resource structure 400 is shown as including 2 slots per subframe, a different number of slots may be included in a subframe (e.g., 4 slots, 8 slots, 16 slots, 32 slots, or another quantity of slots). In some aspects, different types of transmission time intervals (TTIs) may be used, other than subframes and/or slots. A slot 410 may include multiple symbols 415, such as 14 symbols per slot.

The potential control region of a slot 410 may be referred to as a CORESET 420 and may be structured to support an efficient use of resources, such as by flexible configuration or reconfiguration of resources of the CORESET 420 for one or more PDCCHs and/or one or more PDSCHs. In some aspects, the CORESET 420 may occupy the first symbol 415 of a slot 410, the first two symbols 415 of a slot 410, or the first three symbols 415 of a slot 410. Thus, a CORESET 420 may include multiple resource blocks (RBs) in the frequency domain, and either one, two, or three symbols 415 in the time domain. In 5G, a quantity of resources included in the CORESET 420 may be flexibly configured, such as by using RRC signaling to indicate a frequency domain region (e.g., a quantity of resource blocks) and/or a time domain region (e.g., a quantity of symbols) for the CORESET 420.

As illustrated, a symbol 415 that includes CORESET 420 may include one or more control channel elements (CCEs) 425, shown as two CCEs 425 as an example, that span a portion of the system bandwidth. A CCE 425 may include DCI that is used to provide control information for wireless communication. A network node 110 may transmit DCI during multiple CCEs 425 (as shown), where the quantity of CCEs 425 used for transmission of DCI represents the aggregation level (AL) used by the network node 110 for the transmission of DCI. In FIG. 4, an aggregation level of two is shown as an example, corresponding to two CCEs 425 in a slot 410. In some aspects, different aggregation levels may be used, such as 1, 2, 4, 8, 16, or another aggregation level.

Each CCE 425 may include a fixed quantity of resource element groups (REGs) 430, shown as 6 REGs 430, or may include a variable quantity of REGs 430. In some aspects, the quantity of REGs 430 included in a CCE 425 may be specified by a REG bundle size. A REG 430 may include one resource block, which may include 12 resource elements (REs) 435 within a symbol 415. A resource element 435 may occupy one subcarrier in the frequency domain and one OFDM symbol in the time domain.

A search space may include all possible locations (e.g., in time and/or frequency) where a PDCCH may be located. A CORESET 420 may include one or more search spaces, such as a UE-specific search space, a group-common search space, and/or a common search space. A search space may indicate a set of CCE locations where a UE 120 may find PDCCHs that can potentially be used to transmit control information to the UE 120. The possible locations for a PDCCH may depend on whether the PDCCH is a UE-specific PDCCH (e.g., for a single UE 120) or a group-common PDCCH (e.g., for multiple UEs 120) and/or an aggregation level being used. A possible location (e.g., in time and/or frequency) for a PDCCH may be referred to as a PDCCH candidate, and the set of all possible PDCCH locations at an aggregation level may be referred to as a search space. For example, the set of all possible PDCCH locations for a particular UE 120 may be referred to as a UE-specific search space. Similarly, the set of all possible PDCCH locations across all UEs 120 may be referred to as a common search space. The set of all possible PDCCH locations for a particular group of UEs 120 may be referred to as a group-common search space. One or more search spaces across aggregation levels may be referred to as a search space (SS) set.

A CORESET 420 may be interleaved or non-interleaved. An interleaved CORESET 420 may have CCE-to-REG mapping such that adjacent CCEs are mapped to scattered REG bundles in the frequency domain (e.g., adjacent CCEs are not mapped to consecutive REG bundles of the CORESET 420). A non-interleaved CORESET 420 may have a CCE-to-REG mapping such that all CCEs are mapped to consecutive REG bundles (e.g., in the frequency domain) of the CORESET 420.

As indicated above, FIG. 4 is provided as an example. Other examples may differ from what is described with respect to FIG. 4.

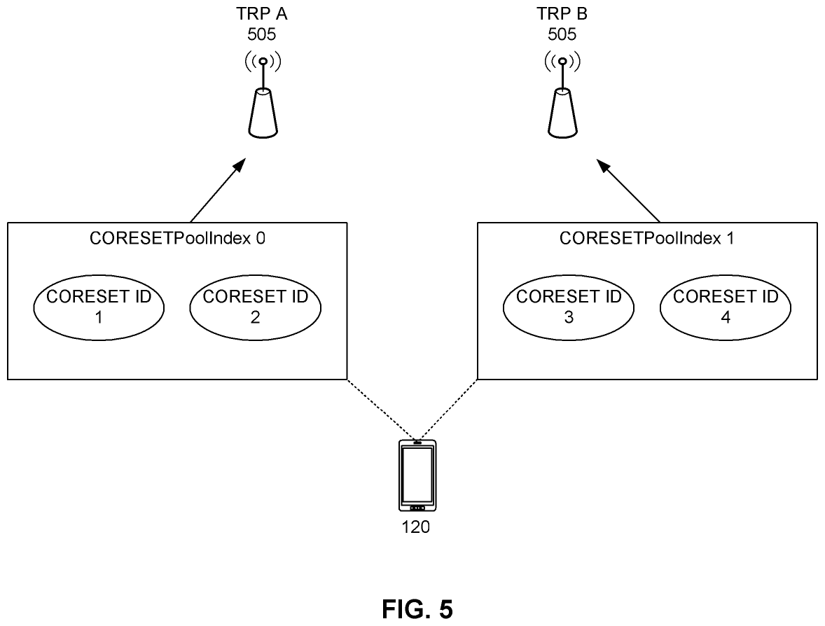

FIG. 5 is a diagram illustrating an example of TRP differentiation at a UE 120 based at least in part on a CORESET pool index, in accordance with the present disclosure. In some aspects, a CORESET pool index (or CORESETPoolIndex) value may be used by a UE 120 to identify a TRP associated with an uplink grant received on a PDCCH.

As illustrated in FIG. 5, a UE 120 may be configured with multiple CORESETs in a given serving cell. Each CORESET configured for the UE 120 may be associated with a CORESET identifier (CORESET ID). For example, a first CORESET configured for the UE 120 may be associated with CORESET ID 1, a second CORESET configured for the UE 120 may be associated with CORESET ID 2, a third CORESET configured for the UE 120 may be associated with CORESET ID 3, and a fourth CORESET configured for the UE 120 may be associated with CORESET ID 4.

As further illustrated in FIG. 5, two or more (for example, up to five) CORESETs may be grouped into a CORESET pool. Each CORESET pool may be associated with a CORESET pool index. As an example, CORESET ID 1 and CORESET ID 2 may be grouped into CORESET pool index 0, and CORESET ID 3 and CORESET ID 4 may be grouped into CORESET pool index 1. In a multi-TRP configuration, each CORESET pool index value may be associated with a particular TRP 505. As an example, and as illustrated in FIG. 5, a first TRP 505 (TRP A) (or a first network node 110) may be associated with CORESET pool index 0 and a second TRP 505 (TRP B) (or a second network node 110) may be associated with CORESET pool index 1. The UE 120 may be configured by a higher layer parameter, such as PDCCH-Config, with information identifying an association between a TRP and a CORESET pool index value assigned to the TRP. Accordingly, the UE may identify the TRP that transmitted a DCI uplink grant by determining the CORESET ID of the CORESET in which the PDCCH carrying the DCI uplink grant was transmitted, determining the CORESET pool index value associated with the CORESET pool in which the CORESET ID is included, and identifying the TRP associated with the CORESET pool index value.

As indicated above, FIG. 5 is provided as an example. Other examples may differ from what is described with respect to FIG. 5.

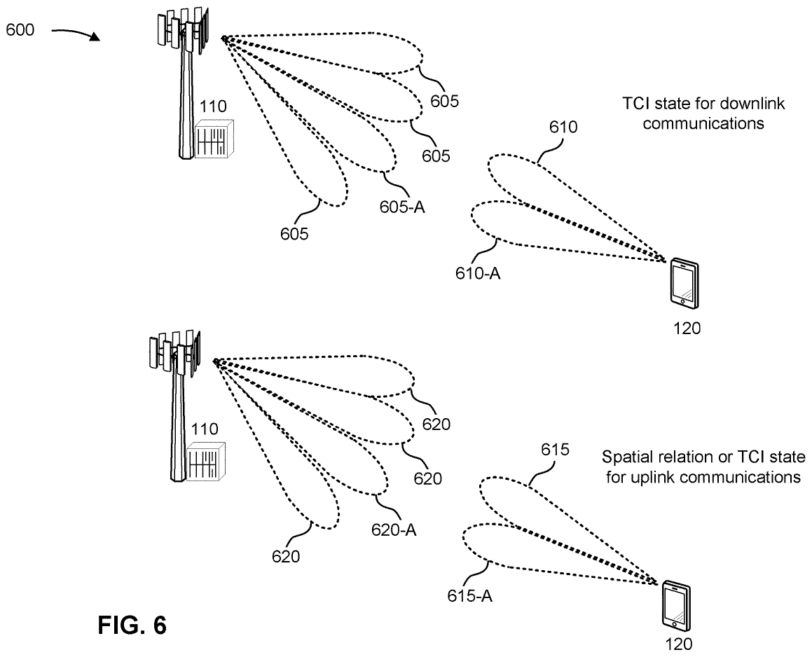

FIG. 6 is a diagram illustrating an example 600 of using beams for access link communications between a network node 110 and a UE 120, in accordance with the present disclosure. As shown in FIG. 6, a network node 110 and a UE 120 may communicate with one another in a wireless network (e.g., wireless network 100).

The network node 110 may transmit to UEs 120 located within a coverage area of the network node 110. The network node 110 and the UE 120 may be configured for beamformed communications, where the network node 110 may transmit in the direction of the UE 120 using a directional NN transmit beam, and the UE 120 may receive the transmission using a directional UE receive beam. Each NN transmit beam may have an associated beam ID, beam direction, or beam symbols, among other examples. The network node 110 may transmit downlink communications via one or more NN transmit beams 605.

The UE 120 may attempt to receive downlink transmissions via one or more UE receive beams 610, which may be configured using different beamforming parameters at receive circuitry of the UE 120. The UE 120 may identify a particular NN transmit beam 605, shown as NN transmit beam 605-A, and a particular UE receive beam 610, shown as UE receive beam 610-A, that provide relatively favorable performance (e.g., that have a best channel quality of the different measured combinations of NN transmit beams 605 and UE receive beams 610). In some examples, the UE 120 may transmit an indication of which NN transmit beam 605 is identified by the UE 120 as a preferred NN transmit beam, which the network node 110 may select for transmissions to the UE 120. The UE 120 may thus attain and maintain a beam pair link (BPL) with the network node 110 for downlink communications (e.g., a combination of the NN transmit beam 605-A and the UE receive beam 610-A), which may be further refined and maintained in accordance with one or more established beam refinement procedures.

A downlink beam, such as a NN transmit beam 605 or a UE receive beam 610, may be associated with a TCI state. A TCI state may indicate a directionality or a characteristic of the downlink beam, such as one or more quasi co-location (QCL) properties of the downlink beam. A QCL property may include, for example, a Doppler shift, a Doppler spread, an average delay, a delay spread, or spatial receive parameters, among other examples. In some examples, a TCI state may be associated with one or more QCL types (sometimes referred to as qclType). For example, in some examples, a TCI state may be associated with one of four QCL types (referred to as QCL-Type A, QCL-Type B, QCL-Type C, and QCL-Type D), which indicate which large scale channel properties are common across QCL channels. More particularly, QCL-Type A may be associated with the channel properties of Doppler shift, Doppler spread, average delay, and delay spread, and may be used for purposes of obtaining channel state information (CSI). QCL-Type B may be associated with the channel properties of Doppler shift and Doppler spread, and similarly may be used for purposes of obtaining CSI. QCL-Type C may be associated with the channel properties of average delay and delay spread, and may be used for purposes of obtaining measurement information (such as RSRP, or the like). And QCL-Type D may be associated with a spatial receiver parameter, and may be used for purposes of supporting beamforming, as is described more fully below.

In some examples, each NN transmit beam 605 may be associated with a synchronization signal block (SSB), and the UE 120 may indicate a preferred NN transmit beam 605 by transmitting uplink transmissions in resources of the SSB that are associated with the preferred NN transmit beam 605. A particular SSB may have an associated TCI state (e.g., for an antenna port or for beamforming). The network node 110 may, in some examples, indicate a downlink NN transmit beam 605 based at least in part on antenna port QCL properties that may be indicated by the TCI state. A TCI state may be associated with one downlink reference signal set (e.g., an SSB and an aperiodic, periodic, or semi-persistent CSI reference signal (CSI-RS)) for different QCL types (e.g., QCL types for different combinations of Doppler shift, Doppler spread, average delay, delay spread, or spatial receive parameters, among other examples). In cases where the QCL type indicates spatial receive parameters (e.g., QCL-Type D), the QCL type may correspond to analog receive beamforming parameters of a UE receive beam 610 at the UE 120. Thus, the UE 120 may select a corresponding UE receive beam 610 from a set of BPLs based at least in part on the network node 110 indicating a NN transmit beam 605 via a TCI indication.

The network node 110 may maintain a set of activated TCI states for downlink shared channel transmissions and a set of activated TCI states for downlink control channel transmissions. The set of activated TCI states for downlink shared channel transmissions may correspond to beams that the network node 110 uses for downlink transmission on a PDSCH. The set of activated TCI states for downlink control channel communications may correspond to beams that the network node 110 may use for downlink transmission on a PDCCH or in a CORESET. The UE 120 may also maintain a set of activated TCI states for receiving the downlink shared channel transmissions and the CORESET transmissions. If a TCI state is activated for the UE 120, then the UE 120 may have one or more antenna configurations based at least in part on the TCI state, and the UE 120 may not need to reconfigure antennas or antenna weighting configurations. In some examples, the set of activated TCI states (e.g., activated PDSCH TCI states and activated CORESET TCI states) for the UE 120 may be configured by a configuration message, such as an RRC message (e.g., an RRCReconfiguration message).

Similarly, for uplink communications, the UE 120 may transmit in the direction of the network node 110 using a directional UE transmit beam, and the network node 110 may receive the transmission using a directional NN receive beam. Each UE transmit beam may have an associated beam identifier (ID), beam direction, or beam symbols, among other examples. The UE 120 may transmit uplink communications via one or more UE transmit beams 615.

The network node 110 may receive uplink transmissions via one or more NN receive beams 620. The network node 110 may identify a particular UE transmit beam 615, shown as UE transmit beam 615-A, and a particular NN receive beam 620, shown as NN receive beam 620-A, that provide relatively favorable performance (e.g., that have a best channel quality of the different measured combinations of UE transmit beams 615 and NN receive beams 620). In some examples, the network node 110 may transmit an indication of which UE transmit beam 615 is identified by the network node 110 as a preferred UE transmit beam, which the network node 110 may select for transmissions from the UE 120. The UE 120 and the network node 110 may thus attain and maintain a BPL for uplink communications (e.g., a combination of the UE transmit beam 615-A and the NN receive beam 620-A), which may be further refined and maintained in accordance with one or more established beam refinement procedures. An uplink beam, such as a UE transmit beam 615 or an NN receive beam 620, may be associated with a spatial relation. A spatial relation may indicate a directionality or a characteristic of the uplink beam, similar to one or more QCL properties, as described above.

Additionally, or alternatively, as shown in FIG. 6, the network node 110 and the UE 120 may communicate using a unified TCI framework, in which case the network node 110 may indicate a TCI state that the UE 120 is to use for beamformed uplink communications. For example, in a unified TCI framework, a joint TCI state (which may be referred to as a joint downlink and uplink TCI state) may be used to indicate a common beam that the UE 120 is to use for downlink communication and uplink communication. In this case, the joint downlink and uplink TCI state may include at least one source reference signal to provide a reference (or UE assumption) for determining QCL properties for a downlink communication or a spatial filter for uplink communication. For example, the joint downlink and uplink TCI state may be associated with one or more source reference signals that provide common QCL information for UE-dedicated PDSCH reception and one or more CORESETs in a component carrier, or one or more source reference signals that provide a reference to determine one or more common uplink transmission spatial filters for a physical uplink shared channel (PUSCH) based on a dynamic grant or a configured grant or one or more dedicated physical uplink control channel (PUCCH) resources in a component carrier.

Additionally, or alternatively, the unified TCI framework may support a separate downlink TCI state and a separate uplink TCI state to accommodate separate downlink and uplink beam indications (e.g., in cases where a best uplink beam does not correspond to a best downlink beam, or vice versa). In such cases, each valid uplink TCI state configuration may contain a source reference signal to indicate an uplink transmit beam for a target uplink communication (e.g., a target uplink reference signal or a target uplink channel). For example, the source reference signal may be a sounding reference signal (SRS), an SSB, or a CSI-RS, among other examples, and the target uplink communication may be a PRACH, a PUCCH, a PUSCH, an SRS, and/or a DMRS (e.g., for a PUCCH or a PUSCH), among other examples. In this way, supporting joint TCI states or separate downlink and uplink TCI states may enable a unified TCI framework for downlink and uplink communications and/or may enable the network node 110 to indicate various uplink QCL relationships (e.g., Doppler shift, Doppler spread, average delay, or delay spread, among other examples) for uplink TCI communication.

In some instances, a UE 120 may receive an indication of a unified TCI state that indicates a TCI state that is different from a TCI state associated with a CORESET. In some other aspects, a UE 120 may receive an indication of a TCI state associated with an SFN PDSCH communication that is different from a TCI state associated with a CORESET. Put another way, in some cases, a CORESET may be associated with a TCI state that does not follow an indicated unified TCI state and/or an indicated TCI state associated with a SFN PDSCH communication. In such instances, if the CORESET at least partially overlaps, in a time domain, with another communication that is associated with an indicated unified TCI state and/or an indicated TCI state associated with a SFN PDSCH communication, the UE 120 may not be capable of receiving both communications using the corresponding TCI states (e.g., beams). Accordingly, in such cases, the UE 120 may fail to receive control signaling (e.g., a PDCCH communication in a CORESET), data communications (e.g., a PDSCH communication associated with a unified TCI state, or an SFN PDSCH communication associated with an indicated TCI state, among other examples), leading to increased communication errors and thus increased latency, decreased throughout, and increased power, computing, and network resource consumption associated with correcting communication errors, among other problems.

Some techniques and apparatuses described herein enable prioritization of a TCI state associated with a CORESET when the CORESET at least partially overlaps, in the time domain, with another communication, such as a PDSCH communication associated with a unified TCI state, an SFN PDSCH communication associated with an indicated TCI state, or a similar communication. For example, in some aspects, a UE 120 may receive a unified TCI indication indicating a unified TCI state associated with a PDSCH communication that at least partially overlaps with a CORESET that is associated with a different TCI state. Based at least in part on the CORESET TCI state being different than the unified TCI state, the UE 120 may prioritize reception of a communication associated with the CORESET (e.g., a PDCCH communication associated with the CORESET) in order to ensure that control information is safely received. In some other aspects, a UE 120 may receive a scheduling DCI for a SFN PDSCH communication that indicates a TCI state associated with the SFN PDSCH communication, with the SFN PDSCH communication at least partially overlapping with a CORESET that is associated with a different TCI state. Based at least in part on the CORESET TCI state being different than the SFN PDSCH communication TCI state, the UE 120 may prioritize reception of a communication associated with the CORESET (e.g., a PDCCH communication associated with the CORESET) in order to ensure that control information is safely received. As a result, communication errors may be reduced, leading to decreased latency, increased throughout, decreased power, computing, and network resource consumption associated with correcting communication errors, and overall more efficient usage of network resources.

As indicated above, FIG. 6 is provided as an example. Other examples may differ from what is described with respect to FIG. 6.

FIG. 7 is a diagram illustrating an example 700 associated with a prioritized TCI state in a unified TCI operation, in accordance with the present disclosure.

FIG. 7 illustrates various signals, communications, or messages that a mobile station (e.g., a UE 120) or other wireless communication device may receive from another wireless communication device (e.g., a network node 110). More particularly, as indicated by reference number 705, a mobile station may receive, from a network node 110 or similar wireless communication device, a TCI indication. The TCI indication may be received via a DCI communication (and thus may sometimes be referred to as a TCI indication DCI), a MAC control element (MAC-CE) communication, or a similar communication. In some aspects, the TCI indication may be a unified TCI indication, as part of a unified TCI framework. The TCI indication may indicate one or more TCI states to be used by the mobile station. For example, the TCI indication may indicate a unified TCI state associated with downlink communications, such as PDSCH communications. In some aspects, a TCI state indicated by the TCI indication may be used as a default TCI state by the mobile station. That is, the TCI state may be a TCI state that is used to receive downlink communications absent either an explicit indication (e.g., from a network node 110 or similar wireless communication device) for the mobile station to use a different TCI state for a particular communication, or a prioritization rule that prioritizes another TCI state over the default TCI state, which is described in more detail below in connection with reference number 730. In that regard, the one or more TCI states indicated by the TCI indication may sometimes be referred to as a default TCI state.

As shown by reference number 710, in some aspects the mobile station may receive a scheduling DCI. The scheduling DCI may indicate one or more resources associated with a forthcoming communication, such as a downlink communication. For example, the scheduling DCI may indicate resources associated with a downlink data transmission. More particularly, in some aspects, the scheduling DCI may indicate resources associated with a PDSCH communication, as shown by reference number 715. In some aspects, the scheduling DCI may be received in a same component carrier as the PDSCH communication (sometimes referred to as a self-scheduled PDSCH communication). In some other aspects, the scheduling DCI may be received in a different component carrier than a component carrier used to receive the PDSCH communication (sometimes referred to as a cross-carrier scheduled PDSCH communication). Moreover, as described above in connection with reference number 705, in some aspects the mobile station may be configured or otherwise indicated with a default TCI state, such as a unified TCI state indicated by the TCI indication described in connection with reference number 705. Accordingly, absent an indication of another TCI state to be used for the PDSCH communication in the scheduling DCI or otherwise, the mobile station may apply the default TCI state to the reception of the PDSCH communication, as indicated by the broken arrow shown by reference number 720. For example, in some aspects, the TCI indication may indicate that a default TCI state and/or a unified TCI state is a TCI state indexed as TCI1. Accordingly, the mobile station may receive the PDSCH communication using a beam associated with TCI1.

In some aspects, times resources associated with the PDSCH communication may at least partially overlap (e.g., overlap in at least one symbol) with a CORESET, such as the CORESET shown by reference number 725. Moreover, in some aspects, the CORESET may not be associated with the default TCI state and/or the unified TCI state (e.g., TCI1 in the example). More particularly, in aspects in which the mobile station received a TCI indication indicating a unified TCI state, the CORESET may have a TCI state not following the indicated TCI state. For example, as shown in FIG. 7, the CORESET may be associated with a TCI state indexed as TCI2. In this regard, there is a risk that the mobile station may not safely receive control information associated with the CORESET (e.g., a PDCCH communication transmitted in the CORESET) if the mobile station applies the default TCI state and/or the unified TCI state (e.g., TCI1) during the time resources associated with the overlapping PDSCH communication and the CORESET.

Accordingly, in some aspects, when a PDSCH communication associated with a default TCI state and/or a unified TCI state (e.g., TCI1) at least partially overlaps with a CORESET associated with another TCI state (e.g., TCI2), the mobile station may prioritize reception of the CORESET (e.g., the mobile station may prioritize reception of a PDCCH communication associated with the CORESET) to ensure control information or the like is safely received by the mobile station. Put another way, the mobile station may use a beam associated with a TCI state associated with the CORESET to receive the PDCCH communication and, if, in some aspects, the PDSCH communication (if the mobile station is able to receive the PDSCH communication using the TCI state associated with the CORESET). More particularly, as shown by reference number 730 and by using an unbroken arrow in FIG. 7 (as opposed to the broken arrow shown in connection with the default TCI state indicated by reference number 720), the CORESET TCI state (e.g., TCI2) may be used by the mobile station to receive the CORESET (e.g., a PDCCH communication associated with the CORESET) and/or the PDSCH communication. In this regard, the mobile station may increase a likelihood that control information carried by a PDCCH communication associated with the CORESET is safely received, notwithstanding that the control information is associated with a TCI state that differs from a default TCI state and/or a unified TCI state.

In some aspects, prioritizing the reception of the PDCCH communication associated with the CORESET (e.g., using a beam associated with the CORESET during the period of time when the CORESET at least partially overlaps with the PDSCH communication) may be based at least in part on whether an offset between the scheduling DCI and the PDSCH communication is below a threshold time duration, sometimes referred to as timeDurationForQCL. The threshold time duration (e.g., timeDurationForQCL) may be associated with a period of time during which QCL parameters associated with a TCI state remain valid. In some aspects, the mobile station may prioritize reception of the PDCCH communication associated with the CORESET based at least in part on an offset between the scheduling DCI communication and the time resources associated with the PDSCH being less than the threshold time duration, as shown in FIG. 7.

Additionally, or alternatively, prioritizing the reception of the PDCCH communication associated with the CORESET (e.g., using a beam associated with the CORESET during the period of time during with the CORESET at least partially overlaps with the PDSCH communication) may be based at least in part on a QCL type associated with the scheduling DCI. More particularly, in some aspects, the mobile station may prioritize reception of the PDCCH communication associated with the CORESET based at least in part on a TCI state associated with the scheduling DCI (which, in the aspect depicted in FIG. 7, is the default TCI state, or TCI1) being associated with QCL-Type D (e.g., a QCL type associated with a spatial receiver parameter for purposes of supporting beamforming).

In some aspects, the operations shown and described in connection with FIG. 7 may be summarized as follows: Independent of the configuration of tci-PresentInDCI and tci-PresentDCI-1-2 in RRC connected mode, if the offset between the reception of the DL DCI and the corresponding self-scheduled or cross-carrier scheduled PDSCH is less than the threshold timeDurationForQCL and at least one configured TCI state for the serving cell of scheduled PDSCH contains qcl-Type set to ‘typeD’, if the default TCI to the scheduled PDSCH is the indicated unified TCI, and if the qcl-Type is set to ‘typeD’ of the PDSCH DMRS from the default TCI is different from that of the PDCCH DMRS with which they overlap in at least one symbol, the UE is expected to prioritize the reception of PDCCH associated with that CORESET. This also applies to the intra-band carrier aggregation case (when the PDSCH and the CORESET are in different component carriers).

As indicated above, FIG. 7 is provided as an example. Other examples may differ from what is described with respect to FIG. 7.

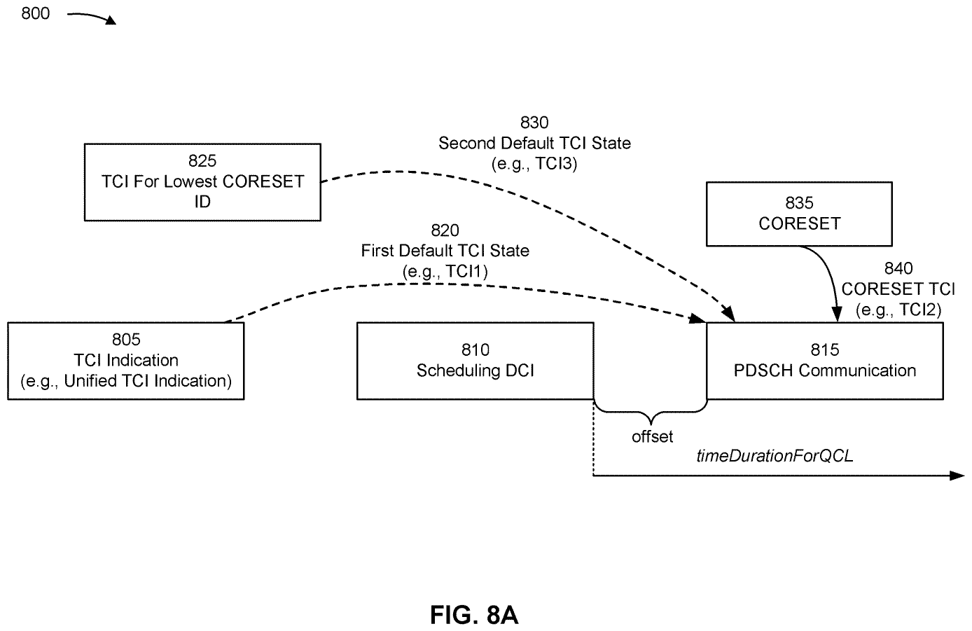

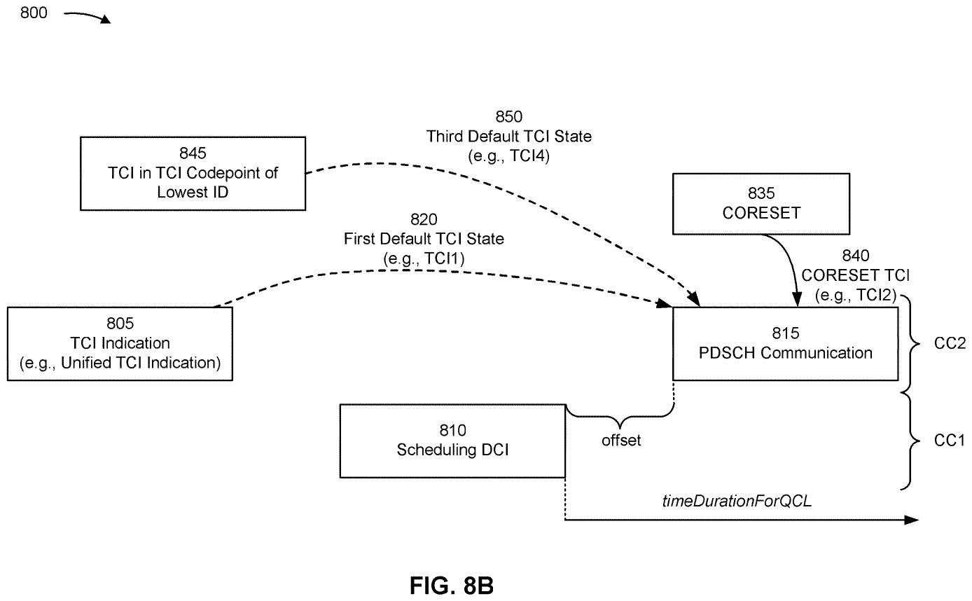

FIGS. 8A-8B are diagrams illustrating another example 800 associated with a prioritized TCI state in a unified TCI operation, in accordance with the present disclosure.

Similar to the signals, communications, and/or messages described in connection with FIG. 7, FIGS. 8A-8B illustrate various signals, communications, or messages that a mobile station (e.g., a UE 120) or other wireless communication device may receive from another wireless communication device (e.g., a network node 110). More particularly, as shown in FIG. 8A as indicated by reference number 805, a mobile station may receive, from a network node 110, a TCI indication. The TCI indication may be received via a DCI indication (e.g., a TCI indication DCI), a MAC-CE communication, or a similar communication. The TCI indication may indicate one or more TCI states to be used by the mobile station. For example, the TCI indication may indicate a unified TCI state associated with downlink communications, such as PDSCH communications. In some aspects, a TCI state indicated by the TCI indication may be used as a default TCI state by the mobile station, in a similar manner as described above in connection with reference number 705.

As shown by reference number 810, in some aspects the mobile station may receive a scheduling DCI, which, similar to the scheduling DCI described in connection with reference number 710, may indicate one or more resources associated with a forthcoming communication, such as resources associated with a PDSCH communication, as shown by reference number 815. In some aspects, the scheduling DCI may be received in a same component carrier as the PDSCH communication (e.g., a self-scheduled PDSCH communication). In some other aspects, the scheduling DCI may be received in a different component carrier than a component carrier used to receive the PDSCH communication (e.g., a cross-carrier scheduled PDSCH communication).

In some aspects, the mobile station may be associated with more than one default TCI state. Moreover, in some aspects, a particular default TCI state to be used to receive a given PDSCH communication may be based at least in part on whether an indicated TCI state (e.g., a unified TCI state indicated by the TCI indication, which may be referred to as a first default state, or TCI1, in the example shown in FIG. 8A) is associated with a physical cell identifier (PCI) that is different from the serving cell PCI. For example, in some aspects, if the indicated TCI is associated with the serving cell PCI (sometimes referred to as intra-cell operation), the mobile station may use the indicated TCI for both mobile-station-dedicated and non-mobile-station-dedicated PDSCH communications. In this regard, the intra-cell operation may result in a prioritization rule similar to that described in connection with FIG. 7 (e.g., based at least in part on the CORESET TCI state being different than the unified TCI state associated with the PDSCH communication, the mobile station may prioritize reception of a PDCCH communication associated with the CORESET). That is, the mobile station may apply the first default TCI state (e.g., the unified TCI state, or TCI1, in this example) to the reception of the PDSCH communication, as indicated by the broken arrow shown by reference number 820.

In some other aspects, if the indicated TCI is associated with a PCI different from the serving cell PCI (sometimes referred to as inter-cell operation), the mobile station may apply a different QCL assumption (e.g., may apply a different TCI state to reception of PDSCH communications). More particularly, as indicated by reference number 825, in some aspects, for inter-cell operation, the mobile station may apply a TCI state associated with a lowest CORESET ID in a latest slot. That is, the mobile station may apply a second default TCI state (e.g., the TCI associated with the lowest CORESET ID, or TCI3, in this example) to the reception of the PDSCH communication, as indicated by the broken arrow shown by reference number 830. Additionally, or alternatively, in some aspects, if a QCL-Type D property associated with multiple default beams in a slot for component carriers in a band are different, a default beam for a component carrier with a lowest ID is prioritized (e.g., a default beam for the component carrier with the lowest ID is applied to all the component carriers in a band).

In any event, whether the mobile station applies the first default TCI state to the PDSCH communication, as described above in connection with reference number 820, or the second default TCI state to the PDSCH communication, as described above in connection with reference number 830, the mobile station may prioritize reception of a communication associated with a CORESET if a TCI state associated with the CORESET differs from the applied default TCI state (e.g., the applied one of the first default TCI state (TCI1) or the second default TCI state (TCI3)). More particularly, in some aspects, times resources associated with a PDSCH communication may at least partially overlap with a CORESET, such as the CORESET shown by reference number 835. Moreover, in some aspects, the CORESET may not be associated with the default TCI state (e.g., the one of TCI1 or TCI3 in the example). More particularly, in aspects in which the mobile station received a TCI indication indicating a unified TCI state, or alternatively when the mobile station applies the TCI state associated with the lowest CORESET ID in the latest slot, the CORESET may not have a TCI state not following the unified TCI state or the TCI state associated with the lowest CORESET ID in the latest slot. For example, as shown in FIG. 8A, the CORESET may be associated with a TCI state indexed as TCI2. In this regard, there is a risk that the mobile station may not safely receive control information associated with the CORESET (e.g., a PDCCH communication transmitted in the CORESET) if the mobile station applies a default TCI state (e.g., TCI1 or TCI3) during the time resources associated with the overlapping PDSCH communication and the CORESET.

Accordingly, in some aspects, when a PDSCH communication associated with a default TCI state (e.g., TCI1 or TCI3) at least partially overlaps with a CORESET associated with another TCI state (e.g., TCI2), the mobile station may prioritize reception of the CORESET (e.g., the mobile station may prioritize reception of a PDCCH communication associated with the CORESET) to ensure control information or the like is safely received by the mobile station. Put another way, the mobile station may use a beam associated with a TCI state associated with the CORESET to receive the PDCCH communication (and, in some aspects, the PDSCH communication, as described above in connection with FIG. 7). More particularly, as shown by reference number 840 and by using an unbroken arrow in FIG. 8A (as opposed to the broken arrow shown in connection with the default TCI states indicated by reference numbers 820 and 830), the CORESET TCI (e.g., TCI2) may be used by the mobile station to receive the CORESET (e.g., a PDCCH communication associated with the CORESET) and/or the PDSCH communication. In this regard, the mobile station may increase a likelihood that control information carried by a PDCCH communication associated with the CORESET is safely received, notwithstanding that the CORESET is associated with a TCI state that differs from a default TCI state.

In a similar manner as described in connection with FIG. 7, in some aspects, prioritizing the reception of the PDCCH communication associated with the CORESET (e.g., using a beam associated with the CORESET during the period of time during with the CORESET at least partially overlaps with the PDSCH communication) may be based at least in part on whether an offset between the scheduling DCI and the PDSCH communication is below a threshold time duration (e.g., timeDurationForQCL). Additionally, or alternatively, prioritizing the reception of the PDCCH communication associated with the CORESET may be based at least in part on a TCI state associated with the scheduling DCI (which, in the aspect depicted in FIG. 8, may be one of the first default TCI state, TCI1, or the second default TCI state, TCI3, as described) being associated with QCL-Type D (e.g., a QCL type associated with a spatial receiver parameter for purposes of supporting beamforming).

As shown in FIG. 8B, in some aspects the scheduling DCI may be received in a first component carrier (CC) (shown as “CC1” in FIG. 8B) and the PDSCH communication scheduled by the scheduling DCI may be received in a second component carrier (shown as “CC2” in FIG. 8B) different from the first component carrier (e.g., the PDSCH communication may be a cross-carrier scheduled PDSCH communication). In such aspects, a default TCI state may be based at least in part on whether an indicated TCI state (e.g., a TCI state indicated by the TCI indication described in connection with reference number 805) is associated with a PCI of the scheduled component carrier (e.g., CC2). More particularly, if the indicated TCI state in the active bandwidth part (BWP) of the scheduled component carrier (e.g., CC2) is associated with the serving cell PCI of the scheduled component carrier, then the mobile station may obtain its QCL assumption for the scheduled PDSCH communication from the indicated TCI state in the active BWP of the scheduled CC (e.g., the first default TCI state (TCI1) in the example shown in FIG. 8B).

However, if the indicated TCI state in the active BWP of the scheduled component carrier (e.g., CC2) is associated with a PCI different from the serving cell PCI of the scheduled component carrier, the mobile station may apply a default TCI state associated with an activated TCI state with the lowest ID applicable to the PDSCH communication. More particularly, as indicated by reference number 845, in some aspects, for cross-carrier scheduling, the mobile station may apply a TCI state associated with an activated TCI state with the lowest ID. That is, the mobile station may apply a third default TCI state (e.g., an activated TCI state with the lowest ID, or TCI4, in this example) to the reception of the PDSCH communication, as indicated by the broken arrow shown by reference number 850. In any event (e.g., whether, for a cross-carrier scheduled PDSCH communication, the mobile station applies the indicated TCI state (e.g., TCI1) or the activated TCI state with the lowest ID (e.g., TCI4)), when a PDSCH communication associated with a default TCI state (e.g., TCI1 or TCI4) at least partially overlaps with a CORESET associated with another TCI state (e.g., TCI2), the mobile station may prioritize reception of the CORESET (e.g., the mobile station may prioritize reception of a PDCCH communication associated with the CORESET) to ensure control information or the like is safely received by the mobile station, as shown by reference number 840 and by using an unbroken arrow in FIG. 8B (as opposed to the broken arrow shown in connection with the default TCI states indicated by reference numbers 820 and 850).

In some aspects, the operations shown and described in connection with FIG. 8B may be summarized as follows: If the PDCCH carrying the scheduling DCI is received on one component carrier, and a PDSCH scheduled by that DCI is on another component carrier: (1) If the indicated TCI in the active BWP of the scheduled component carrier is associated with a PCI different from the serving cell PCI of the scheduled component carrier, and when the UE is configured with enableDefaultBeamForCCS, if the offset between the reception of the DL DCI and the corresponding PDSCH is less than the threshold timeDurationForQCL, or if the DL DCI does not have the TCI field present, the UE obtains its QCL assumption for the scheduled PDSCH from the activated TCI state with the lowest ID applicable to PDSCH in the active BWP of the scheduled CC. In this case, if the qcl-Type is set to ‘typeD’ of the PDSCH DMRS is different from that of the PDCCH DMRS with which they overlap in at least one symbol, the UE is expected to prioritize the reception of PDCCH associated with that CORESET. This also applies to the intra-band carrier aggregation case (when PDSCH and the CORESET are in different component carriers). (2) If the indicated TCI in the active BWP of the scheduled component carrier is associated with a serving cell PCI of the scheduled component carrier, the UE obtains its QCL assumption for the scheduled PDSCH from the indicated TCI in the active BWP of the scheduled component carrier. In this case, if the qcl-Type is set to ‘typeD’ of the PDSCH DMRS is different from that of the PDCCH DMRS with which they overlap in at least one symbol, the UE is expected to prioritize the reception of PDCCH associated with that CORESET. This also applies to the intra-band carrier aggregation case (when PDSCH and the CORESET are in different component carriers).

As indicated above, FIGS. 8A-8B are provided as examples. Other examples may differ from what is described with respect to FIGS. 8A-8B.

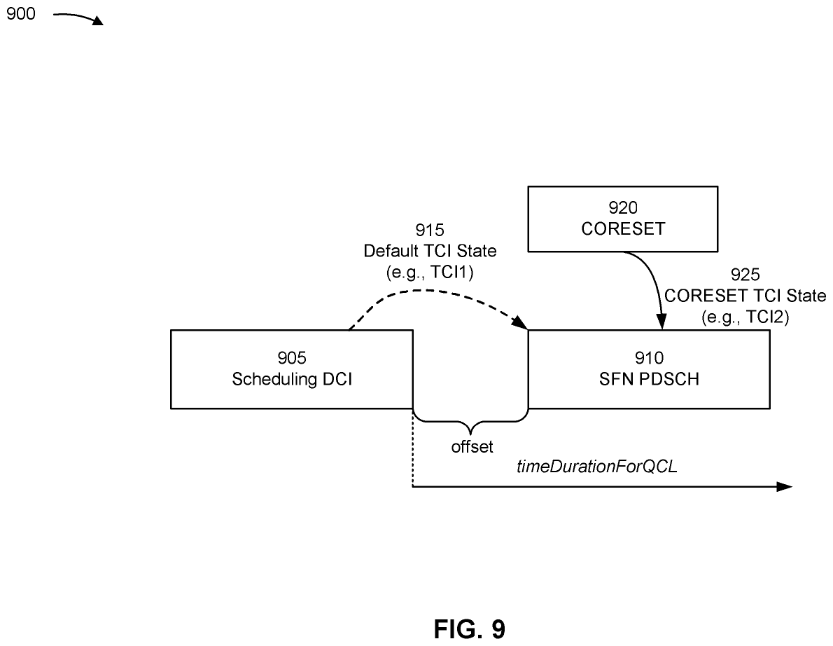

FIG. 9 is a diagram illustrating an example 900 associated with a prioritized TCI state in a single-frequency network operation, in accordance with the present disclosure.

In a similar manner to FIGS. 7-8B, FIG. 9 illustrates various signals, communications, or messages that a mobile station (e.g., a UE 120) or other wireless communication device may receive from another wireless communication device (e.g., a network node 110). More particularly, as shown by reference number 905, in some aspects the mobile station may receive a scheduling DCI, which may indicate resources associated with a downlink data transmission. For example, in some aspects, the scheduling DCI may indicate resources associated with an SFN PDSCH communication, as shown by reference number 910. An SFN PDSCH communication may be a downlink communication associated with a transmission scheme in which multiple transmitters (e.g., multiple network nodes 110) simultaneously send the same signal over the same frequency channel. In some aspects, the scheduling DCI may be received in a same component carrier as the PDSCH communication (e.g., a self-scheduled SFN PDSCH communication), and, in some other aspects, the scheduling DCI may be received in a different component carrier that a component carrier used to receive the PDSCH communication (e.g., a cross-carrier scheduled SFN PDSCH communication). Moreover, in this aspect, the scheduling DCI may indicate a default TCI state associated with the SFN PDSCH communication. Accordingly, absent application of a prioritization rule (as is described in more detail below in connection with reference number 925), the mobile station may apply the default TCI state to the reception of the SFN PDSCH communication, as indicated by the broken arrow shown by reference number 915. For example, in some aspects, the TCI indication may indicate that a default TCI state is a TCI state indexed as TCI1. Accordingly, the mobile station may typically receive the SFN PDSCH communication using a beam associated with TCI1.

In a similar manner as described above in connection with FIGS. 7-8B, in some aspects times resources associated with the SFN PDSCH communication may at least partially overlap with a CORESET, such as the CORESET shown by reference number 920. Moreover, in some aspects, the CORESET may not be associated with the default TCI state (e.g., TCI1 in the example). More particularly, in aspects in which the mobile station received a TCI indication via the scheduling DCI, the CORESET may not have a TCI state not following the indicated TCI state. For example, as shown in FIG. 7, the CORESET may be associated with a TCI state indexed as TCI2. In this regard, there is a risk that the mobile station may not safely receive control information associated with the CORESET (e.g., a PDCCH communication transmitted in the CORESET) if the mobile station applies the default TCI state (e.g., TCI1) during the time resources associated with the overlapping SFN PDSCH communication and the CORESET.

Accordingly, in some aspects, when an SFN PDSCH communication associated with an indicated or default TCI state (e.g., TCI1) at least partially overlaps with a CORESET associated with another TCI state (e.g., TCI2), the mobile station may prioritize reception of the CORESET (e.g., the mobile station may prioritize reception of a PDCCH communication associated with the CORESET) to ensure control information or the like is safely received by the mobile station. Put another way, the mobile station may use a beam associated with a TCI state associated with the CORESET to receive the PDCCH communication (and, in some aspects, the SFN PDSCH communication, in a similar manner as described above in connection with FIGS. 7-8B). More particularly, as shown by reference number 925 and by using an unbroken arrow in FIG. 9 (as opposed to the broken arrow shown in connection with the default TCI state indicated by reference number 915), the CORESET TCI state (e.g., TCI2) may be used by the mobile station to receive the CORESET (e.g., a PDCCH communication associated with the CORESET) and/or the SFN PDSCH communication. In this regard, the mobile station may increase a likelihood that control information carried by a PDCCH communication associated with the CORESET is safely received, notwithstanding that the CORESET is associated with a TCI state that differs from an indicated and/or default TCI state.

In a similar manner as described above in connection with FIGS. 7-8B, in some aspects, prioritizing the reception of the PDCCH communication associated with the CORESET (e.g., using a beam associated with the CORESET during the period of time during with the CORESET at least partially overlaps with the PDSCH communication) may be based at least in part on whether an offset between the scheduling DCI and the SFN PDSCH communication is below a threshold time duration (e.g., timeDurationForQCL). Additionally, or alternatively, prioritizing the reception of the PDCCH communication associated with the CORESET may be based at least in part on a TCI state associated with the scheduling DCI (which, in the aspect depicted in FIG. 9, is the default TCI state, or TCI1) being associated with QCL-Type D (e.g., a QCL type associated with a spatial receiver parameter for purposes of supporting beamforming).

In some aspects, the operations shown and described in connection with FIG. 9 may be summarized as follows: If a UE is not configured with sfnSchemePdsch, and the UE is configured with sfnSchemePdcch set to ‘sfnSchemeA’ and there is no TCI codepoint with two TCI states in the activation command and the CORESET with the lowest ID in the latest slot is indicated with two TCI states, the UE may assume that the DMRS ports of PDSCH of a serving cell are quasi co-located with the reference signal(s) with respect to the QCL parameter(s) associated with the first TCI state of two TCI states indicated for the CORESET. In this case, if the qcl-Type is set to ‘typeD’ of the PDSCH DMRS is different from that of the PDCCH DMRS with which they overlap in at least one symbol, the UE is expected to prioritize the reception of PDCCH associated with that CORESET. This also applies to the intra-band carrier aggregation case (when PDSCH and the CORESET are in different component carriers).

As indicated above, FIG. 9 is provided as an example. Other examples may differ from what is described with respect to FIG. 9.

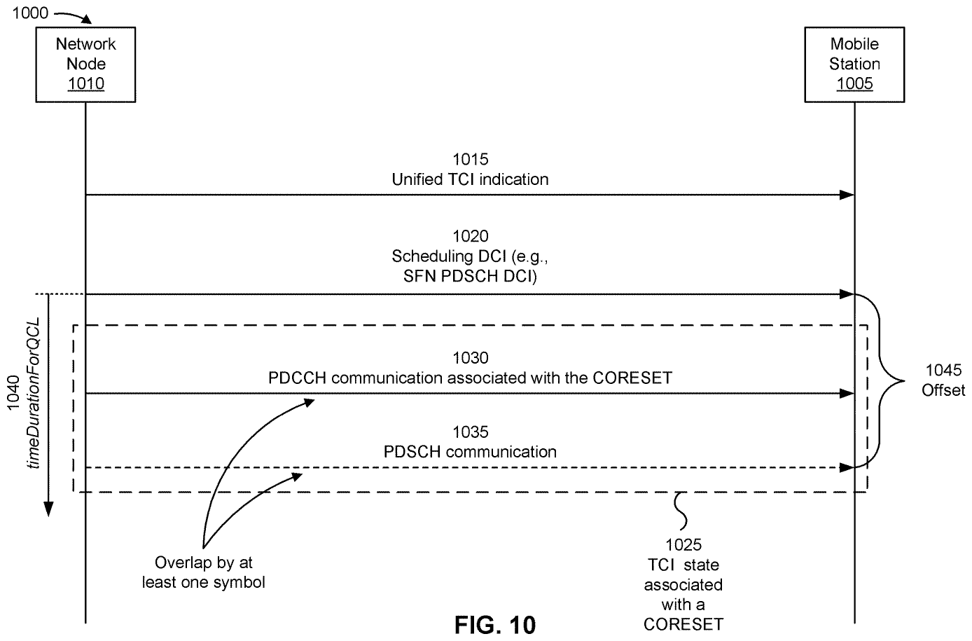

FIG. 10 is a diagram of an example 1000 associated with a prioritized TCI state in a unified TCI or a single-frequency network operation, in accordance with the present disclosure. As shown in FIG. 10, a mobile station 1005 (e.g., a UE 120) may communicate with a network node 1010 (e.g., network node 110). In some aspects, the network node 1010 and the mobile station 1005 may be part of a wireless network (e.g., wireless network 100). The mobile station 1005 and the network node 1010 may have established a wireless connection prior to operations shown in FIG. 10. For example, the mobile station 1005 and the network node 1010 may have established a wireless connection via one or more BPLs, as described above in connection with FIG. 6.

As shown by reference number 1015, the network node 1010 may transmit, and the mobile station 1005 may receive, a unified TCI indication (e.g., an indication associated with a unified TCI framework). In some aspects, the mobile station 1005 may receive the unified TCI indication via one or more MAC-CEs and/or DCI, among other examples. In some aspects, the unified TCI indication may include an indication of one or more parameters (e.g., already known to the mobile station 1005 and/or previously indicated by the network node 1010 or other network device) for selection by the mobile station 1005, and/or explicit information for the mobile station 1005 to use to configure the mobile station 1005, among other examples.

In some aspects, the unified TCI indication may indicate a first TCI state associated with a PDSCH communication (e.g., the PDSCH communication described in connection with 715, the PDSCH communication described in connection with reference number 815, the SFN PDSCH communication described in connection with reference number 910, or a similar PDSCH communication). The mobile station 1005 may configure itself (e.g., configure a default UE receive beam) based at least in part on the unified TCI indication. In some aspects, the mobile station 1005 may be configured to perform one or more operations described herein based at least in part on the unified TCI indication. In some aspects, the mobile station 1005 may enable one or more default UE receive beams based at least in part on the unified TCI indication. For example, the mobile station 1005 may enable a default UE receive beam associated with a TCI state indicated by the unified TCI indication.

As shown by reference number 1020, the network node 1010 may transmit, and the mobile station 1005 may receive, a scheduling DCI communication (e.g., the scheduling DCI described in connection with 710, the scheduling DCI described in connection with reference number 810, the scheduling DCI described in connection with reference number 905, or a similar scheduling DCI) associated with the PDSCH communication. In some aspects, the scheduling DCI communication may be associated with an SFN PDSCH communication, as described above in connection with FIG. 9.

As described above in connection with FIGS. 7-9, in some aspects, time resources associated with a PDSCH communication that is associated with a first TCI state (e.g., a TCI state indicated by a unified TCI indication and/or a TCI state indicated by the scheduling DCI) may at least partially overlap (e.g., overlap by at least one symbol) with time resources associated with a CORESET that is associated with a second TCI state different from the first TCI state. In such aspects, the mobile station 1005 may prioritize reception of a PDCCH communication associated with the CORESET based at least in part on the second TCI state being different from the first TCI state. More particularly, as shown by reference number 1025, to prioritize reception of the PDCCH communication associated with the CORESET, the mobile station may use a TCI state associated with the CORESET when receiving a PDCCH communication associated with the CORESET, as indicated by reference number 1030. In some aspects, the mobile station 1005 may also be capable of receiving the PDSCH communication using the TCI state associated with the CORESET, as shown by reference number 1035. In such aspects, because the mobile station 1005 prioritizes the PDCCH communication (e.g., because the mobile station uses a receive beam associated with the TCI state associated with the CORESET), the PDCCH communication may be more readily received (e.g., received with less interference, communication errors, or the like) than the PDSCH communication, as shown by using an unbroken arrow for the PDCCH communication described in connection with reference number 1030 and by using a broken arrow for the PDSCH communication described in connection with reference number 1035.

In some aspects, the PDSCH communication and the CORESET may be associated with a same component carrier, while, in some other aspects, the PDSCH communication may be associated with a first component carrier and the CORESET may be associated with a second component carrier different from the first component carrier. Moreover, and as described in connection with FIGS. 8A and 8B, in some aspects, the mobile station may be associated with multiple default TCI states, and the TCI state associated with the CORESET may be prioritized over one or more of the multiple default TCI states. For example, in some aspects, the mobile station may be associated with a first default TCI state, such as a unified TCI state, and a second default TCI state, such as a TCI state associated with a lowest CORESET identifier, as described above in connection with FIG. 8A. Moreover, in some aspects, a PCI associated with the first default TCI state (e.g., a unified TCI state) may be different from a PCI associated with a serving cell associated with the PDSCH communication, and a second default state associated with a lowest CORESET identifier may be different from the TCI state associated with the CORESET, as described above in connection with FIG. 8A. In such aspects, prioritizing reception of the PDCCH communication associated with the CORESET may be further based at least in part on the second default TCI state being different from the CORESET TCI state. Additionally, or alternatively, in some aspects, the scheduling DCI communication may be associated with a first component carrier and the PDSCH communication may associated with a second component carrier different from the first component carrier (e.g., the PDSCH communication may be a cross-carrier scheduled PDSCH communication). In such aspects, the second default TCI state may correspond to a TCI state associated with a lowest activated TCI identifier associated with an active bandwidth part. Moreover, the second default TCI state (e.g., the TCI state associated with the lowest activated TCI identifier associated with the active bandwidth part) may be different from the TCI state associated with the CORESET, as described above in connection with FIG. 8B. In such aspects, prioritizing reception of the PDCCH communication associated with the CORESET may be further based at least in part on the second default TCI state being different from the CORESET TCI state.

In some aspects, prioritizing reception of the PDCCH communication associated with the CORESET may be based at least in part on an offset between the scheduling DCI and the PDSCH communication being below a threshold and/or based at least in part on a QCL type of the default TCI state. More particularly, as shown by reference numbers 1040 and 1045, in some aspects, prioritizing reception of the PDCCH communication associated with the CORESET may be further based at least in part on an offset between the scheduling DCI communication and the time resources associated with the PDSCH being less than a threshold time duration (e.g., timeDurationForQCL). Additionally, or alternatively, in some aspects, prioritizing reception of the PDCCH communication associated with the CORESET may further based at least in part on the first TCI state (e.g., the unified TCI state and/or a default TCI state) being associated with a Type D quasi co location type (e.g., QCL-Type D).

Based at least in part on the mobile station 1005 prioritizing reception of the PDCCH communication associated with the CORESET when a CORESET TCI state is different than a PDSCH communication TCI state of an overlapping PDSCH communication, the mobile station 1005 and/or the network node 1010 may conserve computing, power, network, and/or communication resources that may have otherwise been consumed receiving the PDCCH communication and/or the PDSCH communication using the default and/or unified TCI state. For example, based at least in part on the mobile station 1005 prioritizing reception of the PDCCH communication associated with the CORESET when the CORESET TCI state is different than the PDSCH communication TCI state of an overlapping PDSCH communication, the mobile station 1005 may receive control information with a reduced error rate, which may conserve computing, power, network, and/or communication resources that may have otherwise been consumed to detect and/or correct communication errors.

As indicated above, FIG. 10 is provided as an example. Other examples may differ from what is described with respect to FIG. 10.

FIG. 11 is a diagram illustrating an example process 1100 performed, for example, by a mobile station, in accordance with the present disclosure. Example process 1100 is an example where the mobile station (e.g., mobile station 1005) performs operations associated with a prioritized TCI state in unified TCI operation.

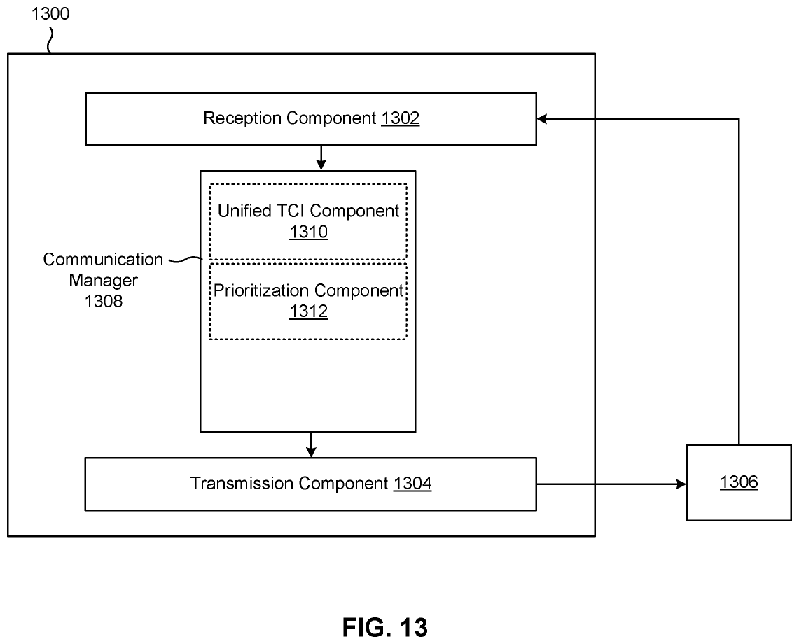

As shown in FIG. 11, in some aspects, process 1100 may include receiving a unified TCI indication indicating a first TCI state associated with a PDSCH communication, wherein time resources associated with the PDSCH communication at least partially overlap with time resources associated with a CORESET associated with a second TCI state different from the first TCI state (block 1110). For example, the mobile station (e.g., using communication manager 1308 and/or reception component 1302, depicted in FIG. 13) may receive a unified TCI indication indicating a first TCI state associated with a PDSCH communication, wherein time resources associated with the PDSCH communication at least partially overlap with time resources associated with a CORESET associated with a second TCI state different from the first TCI state, as described above.

As further shown in FIG. 11, in some aspects, process 1100 may include prioritizing reception of a PDCCH communication associated with the CORESET based at least in part on the second TCI state being different from the first TCI state (block 1120). For example, the mobile station (e.g., using communication manager 1308, unified TCI component 1310, and/or prioritization component 1312, depicted in FIG. 13) may prioritize reception of a PDCCH communication associated with the CORESET based at least in part on the second TCI state being different from the first TCI state, as described above.

Process 1100 may include additional aspects, such as any single aspect or any combination of aspects described below and/or in connection with one or more other processes described elsewhere herein.

In a first aspect, the unified TCI indication is received in at least one of a downlink control information communication or a MAC-CE communication.

In a second aspect, alone or in combination with the first aspect, process 1100 includes receiving a scheduling DCI communication associated with the PDSCH communication, wherein prioritizing reception of the PDCCH communication associated with the CORESET is further based at least in part on an offset between the scheduling DCI communication and the time resources associated with the PDSCH being less than a threshold time duration.

In a third aspect, alone or in combination with one or more of the first and second aspects, prioritizing reception of the PDCCH communication associated with the CORESET is further based at least in part on the first TCI state being associated with a Type D quasi co location type.

In a fourth aspect, alone or in combination with one or more of the first through third aspects, the PDSCH communication and the CORESET are associated with a same component carrier.

In a fifth aspect, alone or in combination with one or more of the first through fourth aspects, the PDSCH communication is associated with a first component carrier, and wherein the CORESET is associated with a second component carrier different from the first component carrier.

In a sixth aspect, alone or in combination with one or more of the first through fifth aspects, a PCI associated with the first TCI state is different from a PCI associated with a serving cell associated with the PDSCH communication, a third TCI state associated with a lowest CORESET identifier is different from the second TCI state, and prioritizing reception of the PDCCH communication associated with the CORESET is further based at least in part on the third TCI state being different from the second TCI state.

In a seventh aspect, alone or in combination with one or more of the first through sixth aspects, process 1100 includes receiving a scheduling DCI communication associated with the PDSCH communication, wherein the scheduling DCI communication is associated with a first component carrier and the PDSCH communication is associated with a second component carrier different from the first component carrier, wherein a third TCI state associated with a lowest activated TCI identifier associated with an active bandwidth part is different from the second TCI state, and wherein prioritizing reception of the PDCCH communication associated with the CORESET is further based at least in part on the third TCI state being different from the second TCI state.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, by a mobile station, in accordance with the present disclosure. Example process 1200 is an example where the mobile station (e.g., mobile station 1005) performs operations associated with prioritized TCI state in single-frequency network operation.

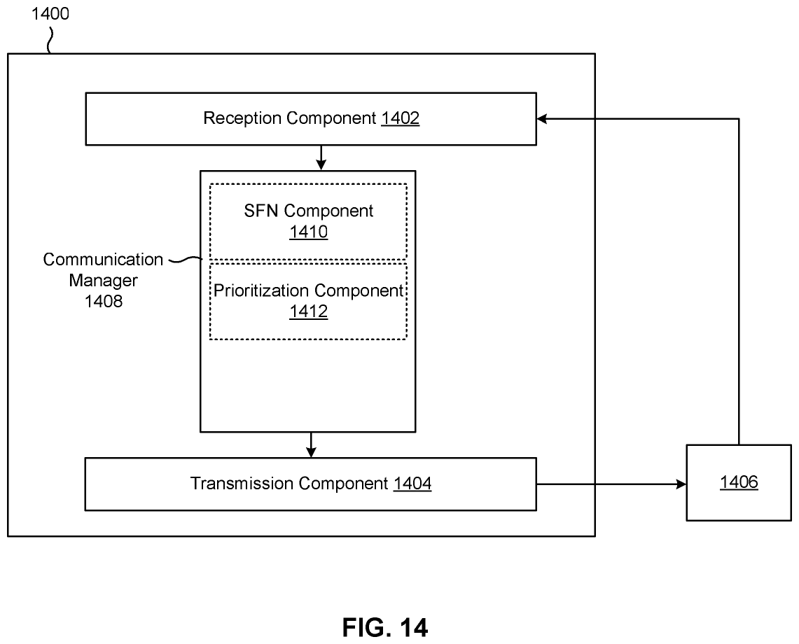

As shown in FIG. 12, in some aspects, process 1200 may include receiving a scheduling DCI communication associated with an SFN PDSCH communication, wherein the scheduling DCI communication indicates a first TCI state associated with the SFN PDSCH communication, and wherein time resources associated with the SFN PDSCH communication at least partially overlap with time resources associated with a CORESET associated with a second TCI state different from the first TCI state (block 1210). For example, the mobile station (e.g., using communication manager 1408 and/or reception component 1402, depicted in FIG. 14) may receive a scheduling DCI communication associated with an SFN PDSCH communication, wherein the scheduling DCI communication indicates a first TCI state associated with the SFN PDSCH communication, and wherein time resources associated with the SFN PDSCH communication at least partially overlap with time resources associated with a CORESET associated with a second TCI state different from the first TCI state, as described above.

As further shown in FIG. 12, in some aspects, process 1200 may include prioritizing reception of a PDCCH communication associated with the CORESET based at least in part on the second TCI state being different from the first TCI state (block 1220). For example, the mobile station (e.g., using communication manager 1408, SFN component 1410, and/or prioritization component 1412, depicted in FIG. 14) may prioritize reception of a PDCCH communication associated with the CORESET based at least in part on the second TCI state being different from the first TCI state, as described above.

Process 1200 may include additional aspects, such as any single aspect or any combination of aspects described below and/or in connection with one or more other processes described elsewhere herein.

In a first aspect, prioritizing reception of the PDCCH communication associated with the CORESET is further based at least in part on an offset between the scheduling DCI communication and the time resources associated with the PDSCH being less than a threshold time duration.

In a second aspect, alone or in combination with the first aspect, prioritizing reception of the PDCCH communication associated with the CORESET is further based at least in part on the first TCI state being associated with a Type D quasi co location type.

In a third aspect, alone or in combination with one or more of the first and second aspects, the PDSCH communication and the CORESET are associated with a same component carrier.

In a fourth aspect, alone or in combination with one or more of the first through third aspects, the PDSCH communication is associated with a first component carrier, and wherein the CORESET is associated with a second component carrier different from the first component carrier.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram of an example apparatus 1300 for wireless communication, in accordance with the present disclosure. The apparatus 1300 may be a mobile station (e.g., mobile station 1005), or a mobile station may include the apparatus 1300. In some aspects, the apparatus 1300 includes a reception component 1302 and a transmission component 1304, which may be in communication with one another (for example, via one or more buses and/or one or more other components). As shown, the apparatus 1300 may communicate with another apparatus 1306 (such as a UE 120, a network node 110, or another wireless communication device) using the reception component 1302 and the transmission component 1304. As further shown, the apparatus 1300 may include the communication manager 1308 (e.g., communication manager 140). The communication manager 1308 may include one or more of a unified TCI component 1310, or a prioritization component 1312, among other examples.

In some aspects, the apparatus 1300 may be configured to perform one or more operations described herein in connection with FIGS. 7-10. Additionally, or alternatively, the apparatus 1300 may be configured to perform one or more processes described herein, such as process 1100 of FIG. 11. In some aspects, the apparatus 1300 and/or one or more components shown in FIG. 13 may include one or more components of the UE 120 described in connection with FIG. 2. Additionally, or alternatively, one or more components shown in FIG. 13 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1302 may receive communications, such as reference signals, control information, data communications, or a combination thereof, from the apparatus 1306. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, a modem, a demodulator, a MIMO detector, a receive processor, a controller/processor, a memory, or a combination thereof, of the UE 120 described in connection with FIG. 2.

The transmission component 1304 may transmit communications, such as reference signals, control information, data communications, or a combination thereof, to the apparatus 1306. In some aspects, one or more other components of the apparatus 1300 may generate communications and may provide the generated communications to the transmission component 1304 for transmission to the apparatus 1306. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1306. In some aspects, the transmission component 1304 may include one or more antennas, a modem, a modulator, a transmit MIMO processor, a transmit processor, a controller/processor, a memory, or a combination thereof, of the UE 120 described in connection with FIG. 2. In some aspects, the transmission component 1304 may be co-located with the reception component 1302 in a transceiver.

The reception component 1302 may receive a unified TCI indication indicating a first TCI state associated with a PDSCH communication, wherein time resources associated with the PDSCH communication at least partially overlap with time resources associated with a CORESET associated with a second TCI state different from the first TCI state. The unified TCI component 1310 and/or the prioritization component 1312 may prioritize reception of a PDCCH communication associated with the CORESET based at least in part on the second TCI state being different from the first TCI state.

The reception component 1302 may receive a scheduling DCI communication associated with the PDSCH communication, wherein prioritizing reception of the PDCCH communication associated with the CORESET is further based at least in part on an offset between the scheduling DCI communication and the time resources associated with the PDSCH being less than a threshold time duration.

The reception component 1302 may receive a DCI communication associated with the PDSCH communication, wherein the scheduling DCI communication is associated with a first component carrier and the PDSCH communication is associated with a second component carrier different from the first component carrier, wherein a third TCI state associated with a lowest activated TCI identifier associated with an active bandwidth part is different from the second TCI state, and wherein prioritizing reception of the PDCCH communication associated with the CORESET is further based at least in part on the third TCI state being different from the second TCI state.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

FIG. 14 is a diagram of an example apparatus 1400 for wireless communication, in accordance with the present disclosure. The apparatus 1400 may be a mobile station (e.g., mobile station 1005), or a mobile station may include the apparatus 1400. In some aspects, the apparatus 1400 includes a reception component 1402 and a transmission component 1404, which may be in communication with one another (for example, via one or more buses and/or one or more other components). As shown, the apparatus 1400 may communicate with another apparatus 1406 (such as a UE 120, a network node 110, or another wireless communication device) using the reception component 1402 and the transmission component 1404. As further shown, the apparatus 1400 may include the communication manager 1408 (e.g., communication manager 140). The communication manager 1408 may include one or more of an SFN component 1410, or a prioritization component 1412, among other examples.

In some aspects, the apparatus 1400 may be configured to perform one or more operations described herein in connection with FIGS. 7-10. Additionally, or alternatively, the apparatus 1400 may be configured to perform one or more processes described herein, such as process 1200 of FIG. 12. In some aspects, the apparatus 1400 and/or one or more components shown in FIG. 14 may include one or more components of the UE 120 described in connection with FIG. 2. Additionally, or alternatively, one or more components shown in FIG. 14 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1402 may receive communications, such as reference signals, control information, data communications, or a combination thereof, from the apparatus 1406. The reception component 1402 may provide received communications to one or more other components of the apparatus 1400. In some aspects, the reception component 1402 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1400. In some aspects, the reception component 1402 may include one or more antennas, a modem, a demodulator, a MIMO detector, a receive processor, a controller/processor, a memory, or a combination thereof, of the UE 120 described in connection with FIG. 2.

The transmission component 1404 may transmit communications, such as reference signals, control information, data communications, or a combination thereof, to the apparatus 1406. In some aspects, one or more other components of the apparatus 1400 may generate communications and may provide the generated communications to the transmission component 1404 for transmission to the apparatus 1406. In some aspects, the transmission component 1404 may perform signal processing on the generated communications (such as filtering, amplification, modulation, digital-to-analog conversion, multiplexing, interleaving, mapping, or encoding, among other examples), and may transmit the processed signals to the apparatus 1406. In some aspects, the transmission component 1404 may include one or more antennas, a modem, a modulator, a transmit MIMO processor, a transmit processor, a controller/processor, a memory, or a combination thereof, of the UE 120 described in connection with FIG. 2. In some aspects, the transmission component 1404 may be co-located with the reception component 1402 in a transceiver.

The reception component 1402 may receive a scheduling DCI communication associated with a SFN PDSCH communication, wherein the scheduling DCI communication indicates a first TCI state associated with the SFN PDSCH communication, and wherein time resources associated with the SFN PDSCH communication at least partially overlap with time resources associated with a CORESET associated with a second TCI state different from the first TCI state. The SFN component 1410 and/or the prioritization component 1412 may prioritize reception of a PDCCH communication associated with the CORESET based at least in part on the second TCI state being different from the first TCI state.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

The following provides an overview of some Aspects of the present disclosure:

Aspect 1: A method of wireless communication performed by a mobile station, comprising: receiving, by the mobile station, a unified TCI indication indicating a first TCI state associated with a PDSCH communication, wherein time resources associated with the PDSCH communication at least partially overlap with time resources associated with a CORESET associated with a second TCI state different from the first TCI state; and prioritizing, by the mobile station, reception of a PDCCH communication associated with the CORESET based at least in part on the second TCI state being different from the first TCI state.

Aspect 2: The method of Aspect 1, wherein the unified TCI indication is received in at least one of a downlink control information communication or a MAC-CE communication.

Aspect 3: The method of any of Aspects 1-2, further comprising receiving, by the mobile station, a scheduling DCI communication associated with the PDSCH communication, wherein prioritizing reception of the PDCCH communication associated with the CORESET is further based at least in part on an offset between the scheduling DCI communication and the time resources associated with the PDSCH being less than a threshold time duration.

Aspect 4: The method of any of Aspects 1-3, wherein prioritizing reception of the PDCCH communication associated with the CORESET is further based at least in part on the first TCI state being associated with a Type D quasi co location type.

Aspect 5: The method of any of Aspects 1-4, wherein the PDSCH communication and the CORESET are associated with a same component carrier.

Aspect 6: The method of any of Aspects 1-4, wherein the PDSCH communication is associated with a first component carrier, and wherein the CORESET is associated with a second component carrier different from the first component carrier.

Aspect 7: The method of any of Aspects 1-6, wherein a PCI associated with the first TCI state is different from a PCI associated with a serving cell associated with the PDSCH communication, wherein a third TCI state associated with a lowest CORESET identifier is different from the second TCI state, and wherein prioritizing reception of the PDCCH communication associated with the CORESET is further based at least in part on the third TCI state being different from the second TCI state.

Aspect 8: The method of any of Aspects 1-7, further comprising receiving, by the mobile station, a scheduling DCI communication associated with the PDSCH communication, wherein the scheduling DCI communication is associated with a first component carrier and the PDSCH communication is associated with a second component carrier different from the first component carrier, wherein a third TCI state associated with a lowest activated TCI identifier associated with an active bandwidth part is different from the second TCI state, and wherein prioritizing reception of the PDCCH communication associated with the CORESET is further based at least in part on the third TCI state being different from the second TCI state.

Aspect 9: A method of wireless communication performed by a mobile station, comprising: receiving, by the mobile station, a scheduling DCI communication associated with an SFN PDSCH communication, wherein the scheduling DCI communication indicates a first TCI state associated with the SFN PDSCH communication, and wherein time resources associated with the SFN PDSCH communication at least partially overlap with time resources associated with a CORESET associated with a second TCI state different from the first TCI state; and prioritizing, by the mobile station, reception of a PDCCH communication associated with the CORESET based at least in part on the second TCI state being different from the first TCI state.

Aspect 10: The method of Aspect 9, wherein prioritizing reception of the PDCCH communication associated with the CORESET is further based at least in part on an offset between the scheduling DCI communication and the time resources associated with the PDSCH being less than a threshold time duration.

Aspect 11: The method of any of Aspects 9-10, wherein prioritizing reception of the PDCCH communication associated with the CORESET is further based at least in part on the first TCI state being associated with a Type D quasi co location type.

Aspect 12: The method of any of Aspects 9-11, wherein the PDSCH communication and the CORESET are associated with a same component carrier.

Aspect 13: The method of any of Aspects 9-11, wherein the PDSCH communication is associated with a first component carrier, and wherein the CORESET is associated with a second component carrier different from the first component carrier.

Aspect 14: An apparatus for wireless communication at a device, comprising a processor; memory coupled with the processor; and instructions stored in the memory and executable by the processor to cause the apparatus to perform the method of one or more of Aspects 1-8.

Aspect 15: A device for wireless communication, comprising a memory and one or more processors coupled to the memory, the one or more processors configured to perform the method of one or more of Aspects 1-8.

Aspect 16: An apparatus for wireless communication, comprising at least one means for performing the method of one or more of Aspects 1-8.

Aspect 17: A non-transitory computer-readable medium storing code for wireless communication, the code comprising instructions executable by a processor to perform the method of one or more of Aspects 1-8.

Aspect 18: A non-transitory computer-readable medium storing a set of instructions for wireless communication, the set of instructions comprising one or more instructions that, when executed by one or more processors of a device, cause the device to perform the method of one or more of Aspects 1-8.

Aspect 19: An apparatus for wireless communication at a device, comprising a processor; memory coupled with the processor; and instructions stored in the memory and executable by the processor to cause the apparatus to perform the method of one or more of Aspects 9-13.

Aspect 20: A device for wireless communication, comprising a memory and one or more processors coupled to the memory, the one or more processors configured to perform the method of one or more of Aspects 9-13.

Aspect 21: An apparatus for wireless communication, comprising at least one means for performing the method of one or more of Aspects 9-13.

Aspect 22: A non-transitory computer-readable medium storing code for wireless communication, the code comprising instructions executable by a processor to perform the method of one or more of Aspects 9-13.

Aspect 23: A non-transitory computer-readable medium storing a set of instructions for wireless communication, the set of instructions comprising one or more instructions that, when executed by one or more processors of a device, cause the device to perform the method of one or more of Aspects 9-13.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A method of wireless communication performed by a mobile station, comprising:
receiving, by the mobile station, a unified transmission configuration indicator (TCI) indication indicating a first TCI state associated with a physical downlink shared channel (PDSCH) communication, wherein time resources associated with the PDSCH communication at least partially overlap with time resources associated with a control resource set (CORESET) associated with a second TCI state different from the first TCI state; and
prioritizing, by the mobile station, reception of a physical downlink control channel (PDCCH) communication associated with the CORESET based at least in part on the second TCI state being different from the first TCI state.

2. The method of claim 1, wherein the unified TCI indication is received in at least one of a downlink control information communication or a medium access control (MAC) control element (MAC-CE) communication.

3. The method of claim 1, further comprising receiving, by the mobile station, a scheduling downlink control information (DCI) communication associated with the PDSCH communication, wherein prioritizing reception of the PDCCH communication associated with the CORESET is further based at least in part on an offset between the scheduling DCI communication and the time resources associated with the PDSCH being less than a threshold time duration.

4. The method of claim 1, wherein prioritizing reception of the PDCCH communication associated with the CORESET is further based at least in part on the first TCI state being associated with a Type D quasi co location type.

5. The method of claim 1, wherein the PDSCH communication and the CORESET are associated with a same component carrier.

6. The method of claim 1, wherein the PDSCH communication is associated with a first component carrier, and wherein the CORESET is associated with a second component carrier different from the first component carrier.

7. The method of claim 1, wherein a physical cell identifier (PCI) associated with the first TCI state is different from a PCI associated with a serving cell associated with the PDSCH communication, wherein a third TCI state associated with a lowest CORESET identifier is different from the second TCI state, and wherein prioritizing reception of the PDCCH communication associated with the CORESET is further based at least in part on the third TCI state being different from the second TCI state.

8. The method of claim 1, further comprising receiving, by the mobile station, a scheduling downlink control information (DCI) communication associated with the PDSCH communication, wherein the scheduling DCI communication is associated with a first component carrier and the PDSCH communication is associated with a second component carrier different from the first component carrier, wherein a third TCI state associated with a lowest activated TCI identifier associated with an active bandwidth part is different from the second TCI state, and wherein prioritizing reception of the PDCCH communication associated with the CORESET is further based at least in part on the third TCI state being different from the second TCI state.

9. A method of wireless communication performed by a mobile station, comprising:
receiving, by the mobile station, a scheduling downlink control information (DCI) communication associated with a single-frequency network (SFN) physical downlink shared channel (PDSCH) communication, wherein the scheduling DCI communication indicates a first TCI state associated with the SFN PDSCH communication, and wherein time resources associated with the SFN PDSCH communication at least partially overlap with time resources associated with a control resource set (CORESET) associated with a second TCI state different from the first TCI state; and
prioritizing, by the mobile station, reception of a physical downlink control channel (PDCCH) communication associated with the CORESET based at least in part on the second TCI state being different from the first TCI state.

10. The method of claim 9, wherein prioritizing reception of the PDCCH communication associated with the CORESET is further based at least in part on an offset between the scheduling DCI communication and the time resources associated with the PDSCH being less than a threshold time duration.

11. The method of claim 9, wherein prioritizing reception of the PDCCH communication associated with the CORESET is further based at least in part on the first TCI state being associated with a Type D quasi co location type.

12. The method of claim 9, wherein the PDSCH communication and the CORESET are associated with a same component carrier.

13. The method of claim 9, wherein the PDSCH communication is associated with a first component carrier, and wherein the CORESET is associated with a second component carrier different from the first component carrier.

14. A mobile station for wireless communication, comprising:
a memory; and
one or more processors, coupled to the memory and based at least in part on information stored in the memory, configured to:
receive a unified transmission configuration indicator (TCI) indication indicating a first TCI state associated with a physical downlink shared channel (PDSCH) communication, wherein time resources associated with the PDSCH communication at least partially overlap with time resources associated with a control resource set (CORESET) associated with a second TCI state different from the first TCI state; and
prioritize reception of a physical downlink control channel (PDCCH) communication associated with the CORESET based at least in part on the second TCI state being different from the first TCI state.

15. The mobile station of claim 14, wherein the unified TCI indication is received in at least one of a downlink control information communication or a medium access control (MAC) control element (MAC-CE) communication.

16. The mobile station of claim 14, wherein the one or more processors are further configured to receive a scheduling downlink control information (DCI) communication associated with the PDSCH communication, wherein prioritizing reception of the PDCCH communication associated with the CORESET is further based at least in part on an offset between the scheduling DCI communication and the time resources associated with the PDSCH being less than a threshold time duration.

17. The mobile station of claim 14, wherein prioritizing reception of the PDCCH communication associated with the CORESET is further based at least in part on the first TCI state being associated with a Type D quasi co location type.

18. The mobile station of claim 14, wherein the PDSCH communication and the CORESET are associated with a same component carrier.

19. The mobile station of claim 14, wherein the PDSCH communication is associated with a first component carrier, and wherein the CORESET is associated with a second component carrier different from the first component carrier.

20. The mobile station of claim 14, wherein a physical cell identifier (PCI) associated with the first TCI state is different from a PCI associated with a serving cell associated with the PDSCH communication, wherein a third TCI state associated with a lowest CORESET identifier is different from the second TCI state, and wherein prioritizing reception of the PDCCH communication associated with the CORESET is further based at least in part on the third TCI state being different from the second TCI state.

21. The mobile station of claim 14, wherein the one or more processors are further configured to receive a scheduling downlink control information (DCI) communication associated with the PDSCH communication, wherein the scheduling DCI communication is associated with a first component carrier and the PDSCH communication is associated with a second component carrier different from the first component carrier, wherein a third TCI state associated with a lowest activated TCI identifier associated with an active bandwidth part is different from the second TCI state, and wherein prioritizing reception of the PDCCH communication associated with the CORESET is further based at least in part on the third TCI state being different from the second TCI state.

22. A mobile station for wireless communication, comprising:
a memory; and
one or more processors, coupled to the memory and based at least in part on information stored in the memory, configured to:
receive a scheduling downlink control information (DCI) communication associated with a single-frequency network (SFN) physical downlink shared channel (PDSCH) communication, wherein the scheduling DCI communication indicates a first TCI state associated with the SFN PDSCH communication, and wherein time resources associated with the SFN PDSCH communication at least partially overlap with time resources associated with a control resource set (CORESET) associated with a second TCI state different from the first TCI state; and
prioritize reception of a physical downlink control channel (PDCCH) communication associated with the CORESET based at least in part on the second TCI state being different from the first TCI state.

23. The mobile station of claim 22, wherein prioritizing reception of the PDCCH communication associated with the CORESET is further based at least in part on an offset between the scheduling DCI communication and the time resources associated with the PDSCH being less than a threshold time duration.

24. The mobile station of claim 22, wherein prioritizing reception of the PDCCH communication associated with the CORESET is further based at least in part on the first TCI state being associated with a Type D quasi co location type.

25. The mobile station of claim 22, wherein the PDSCH communication and the CORESET are associated with a same component carrier.

26. The mobile station of claim 22, wherein the PDSCH communication is associated with a first component carrier, and wherein the CORESET is associated with a second component carrier different from the first component carrier.

27-30. (canceled)
